(19) United States
(12) Patent Application Publication
(10) Pub. No.: US 2025/0341075 A1
(43) Pub. Date: Nov. 6, 2025

(54) Jaw Set With Modular Platforms And Interchangeable Working Shields

(71) Applicant: Michael Richard Ramun, Mineral Ridge, OH (US)

(72) Inventor: Michael Richard Ramun, Mineral Ridge, OH (US)

(21) Appl. No.: 19/006,556

(22) Filed: Dec. 31, 2024

Related U.S. Application Data
(63) Continuation-in-part of application No. 18/524,969, filed on Nov. 30, 2023.

(51) Int. Cl. E02F 3/96; E02F 3/36

(52) U.S. Cl. CPC E02F 3/965; E02F 3/3604

(57) ABSTRACT

A tool attachment system for demolition, recycling, and/or material processing applications wherein a platform is part of a jaw of a jaw set. A segment shield, which may be a segment or a segment shell and base, with working surfaces is attached to the platform such that the segment shield protects the platform from a workpiece. Additionally, the segment may be customized for a particular task thereby providing optimum performance. Furthermore, a jaw set may be configured so that a first jaw and second jaw act together to shear a workpiece into a particular shape that will pass through an opening of the second jaw thereby not only retaining the shape of the workpiece but also allowing a workpiece to be cut to a particular shape.

### CROSS REFERENCE TO RELATED APPLICATIONS

This application is a continuation-in-part of U.S. application Ser. No. 18/524,969 filed Nov. 30, 2023.

### BACKGROUND OF THE INVENTION

### Field of the Invention

The present invention relates to a tool attachment system for demolition, recycling, and/or material processing equipment. More particularly, the present invention relates to interchangeable platforms that are most commonly connected to booms, or arms of excavators, or other machinery and interchangeable segments that may be attached to each platform.

### Background Information

The present application refers to demolition, recycling, and/or material processing equipment. Such a description includes, but is not intended to be restrictive of, the equipment being referenced. Demolition equipment may include heavy duty metal cutting shears, grapples, and concrete processors, which may be mounted on excavators and other machinery, which power hydraulic cylinders for a variety of jobs in the demolition and recycling industries.

In the dismantling of an industrial structure, metal scrap in the form of various diameter pipes, structural I-beams, channels, angles, and sheet metal plates must be efficiently severed and handled by heavy duty metal shears. Metal shears can also be utilized for reducing automobiles, truck frames, and railroad cars. The shears must be able to move and cut the metal scrap into pieces without any significant damage to the shears. In the demolition of industrial structures, concrete crackers are also used to reduce concrete structures into to manageable components, which can then be easily handled and removed from the site. Wood shears and plate shears also represent specialized cutting devices, which are useful, in particular, for demolition or debris removal situations, depending upon the type of material to be cut. Further, a grapple is often utilized where handling of debris or workpieces is a primary function of the equipment. Historically, all of these pieces of equipment represent distinct tools having significant independent capital cost. Consequently, the demolition industry has tended to develop one type of tool associated with each body.

U.S. Pat. No. 7,354,010, hereinafter the '010 patent, is directed to a single jaw set multiple tool attachment system and begins to address this challenge. The '010 patent teaches a single jaw set that accepts multiple inserts such that the jaws may be customized for particular tasks. However, the '010 patent utilizes pivoting jaws and adds a variety of different components directly to these jaws for these different tasks. One jaw configuration may be useable for many tasks and may be optimal for one task. However, the configuration is not optimal for many of the other tasks for which the jaws may be used.

As an example, in FIG. 13 of the '010 patent, the apex 38 is typically used to maximize shear upon a workpiece. However, such a feature hinders the performance of the jaws in other applications for which the jaws may be used.

The Applicant has realized that it is possible to provide a jaw set and include platforms on the jaws of the jaw set with customized segments that may be attached to these platforms to provide a tool that is fully dedicated to a particular function for optimum performance.

### SUMMARY OF THE INVENTION

A jaw set for demolition, recycling, or material processing equipment has a first jaw and a second jaw. The first jaw is configured to be secured with a pivot pin about a pivot group and adapted to allow relative rotation between the first jaw and the second jaw. Each jaw has a front end and an inner surface, wherein with each jaw in a closed position, a throat is defined by the overlapping portion of the inner surface of the two jaws at a point closest to the pivot group. Each jaw has a platform extending along the inner surface from the front end of the jaw to the throat. The platform with the jaws in the closed position has a platform length defined by a perpendicular projection from a line extending from the front end of the platform to the throat. A working shield is secured to the jaw. The working shield has working surfaces for engaging a workpiece and wherein the working shield has a cavity with a shape complimentary to the platform. The working shield covers portions of the platform that experience compressive forces when the jaws are moved against a workpiece from an open position to a closed position.

In another embodiment, a jaw set has a first jaw and a second jaw with features similar to the jaws just discussed. However, this first jaw has a first pivot pin and the second jaw has a second pivot pin. Each of these pivot pins is separated from the other but attached to a common receiver.

In yet another embodiment, only a first jaw has associated with it a working shield attached thereto, while the second jaw has a dedicated arrangement compatible with the working shield of the first jaw.

In yet another embodiment, the jaw set is a shear and the outer profile of the first jaw inner shear blades fit within the inner profile of the second blade inner blades of the second jaw such that upon moving the jaws from the open to the closed position, the second jaw provides lateral support to the first jaw.

### BRIEF DESCRIPTION OF THE DRAWINGS

FIG. 1 is a hydraulic machine with a concrete cracker attached to the end of a boom;

FIGS. 2A and 2B illustrate the concrete cracker of FIG. 1 in the open position;

FIG. 2C is the concrete cracker illustrated in FIGS. 2A and 2B in the closed position;

FIG. 3 is an exploded view of two jaws with platforms thereupon;

FIG. 4 is a view of a segment inverted to illustrate the compatible surfaces with a platform;

FIG. 5 is a view of the segment secured to the platform;

FIGS. 6A through 6D illustrate various views of the segment/platform configuration of FIG. 5;

FIG. 7 illustrates a perspective exploded view of a jaw set with platforms in accordance with the subject invention;

FIG. 8 illustrates an exploded end view of the jaw set of FIG. 7;

FIG. 9 is a view showing the jaw set of FIG. 7 assembled;

FIG. 10 is an end view of the jaw set of FIG. 7;

FIG. 11 is a cutaway view of the jaw set along line “11-11” in FIG. 7;

FIG. 12 is an end view similar to that of FIG. 10, but with the receivers removed for clarity;

FIGS. 13 through 17 illustrates the steps to attach a segment to a platform;

FIGS. 18A and 18B illustrate what will be defined as two 0° platforms;

FIGS. 19A and 19B illustrate what will be defined as two 45° platforms;

FIGS. 20A and 20B illustrate a combination of one 0° platform and one 45° platform;

FIGS. 21A and 21B represent a combination of one 45° platform and one 0° platform;

FIGS. 22A-22C illustrate a concrete cracker in accordance with one embodiment of the subject invention;

FIGS. 23A-23C illustrate a concrete crusher in accordance with one embodiment of the subject invention;

FIGS. 24A-24C illustrate a cast breaker in accordance with one embodiment of the subject invention;

FIGS. 25A-25C illustrate a rail breaker in accordance with one embodiment of the subject invention;

FIGS. 26A-26C illustrate a sorting tine in accordance with one embodiment of the subject invention;

FIGS. 27A-27C illustrate a grapple tine in accordance with one embodiment of the subject invention;

FIGS. 28A-28C illustrate segment bases for fabrication in accordance with one embodiment of the subject invention;

FIGS. 29A-29C illustrate segment bases for fabrication coupled with one embodiment of a bucket;

FIGS. 30A-30C illustrate segment bases for fabrication coupled with one embodiment of a grab;

FIGS. 31A-31C illustrate a tree shear in accordance with one embodiment of the subject invention;

FIGS. 32A-32C illustrate a removeable segment secured to a platform on one jaw and a dedicated second jaw without a platform and, in this instance, a removeable heavy melt shear knife coupled with a heavy melt dedicated shear anvil in accordance with one embodiment of the subject invention;

FIGS. 33A-33C illustrate a slab processor in accordance with one embodiment of the subject invention;

FIG. 34 illustrates a hydraulic machine wherein a cylinder activates a link associated with each jaw such that each jaw moves;

FIG. 35 illustrates a hydraulic cylinder wherein one set of jaws is fixed while the hydraulic cylinder moves only the other jaw;

FIGS. 36A-36C illustrate a concrete crusher in accordance with one embodiment of the subject invention;

FIG. 37 illustrates an exploded view of a segment shell, a base, and a jaw with a platform;

FIG. 38 illustrates an arrangement whereby the base covers essentially all of the platform and the segment shell covers the base;

FIG. 39 illustrates an arrangement whereby the segment shell covers the base and also covers a portion of the platform;

FIG. 40 illustrates an arrangement whereby the base covers the entire working area of the platform and the segment shell covers a portion of the base;

FIG. 41 illustrates the technique for determining what portion of the inner surface of the platform is covered by the working shield for one set of jaws in the closed position;

FIG. 42 illustrates the technique for determining what portion of the inner surface of the platform is covered by the working shield for another set of jaws in the closed position.

FIGS. 43A-43C illustrate a jaw set with a platform covered by only a base;

FIG. 44 illustrates the manner by which a base is positioned on a jaw;

FIG. 45 illustrates a base without a front end;

FIGS. 46-48 illustrate details of the segment shell and base and the how they are connected;

FIG. 49 illustrates the details of a segment shell, base, and jaw shown in an exploded arrangement;

FIGS. 50A-50C illustrate a bucket in accordance with one embodiment of the subject invention;

FIGS. 51A-51C illustrate a tree shear in accordance with one embodiment of the subject invention;

FIGS. 52A-52C illustrate a rail breaker in accordance with one embodiment of the subject invention;

FIGS. 53A-53C illustrate a grapple in accordance with one embodiment of the subject invention;

FIGS. 54A-54C illustrate a combination cutter in accordance with one embodiment of the subject invention;

FIGS. 55A-55C illustrate a bucket grab in accordance with one embodiment of the subject invention;

FIG. 56 illustrates a jaw set whereby each jaw is mounted to a separate pivot pin; and

FIG. 57 is an enlarged duplicate of FIG. 32A showing in greater detail the features of the arrangement.

### DESCRIPTION OF THE PREFERRED EMBODIMENTS

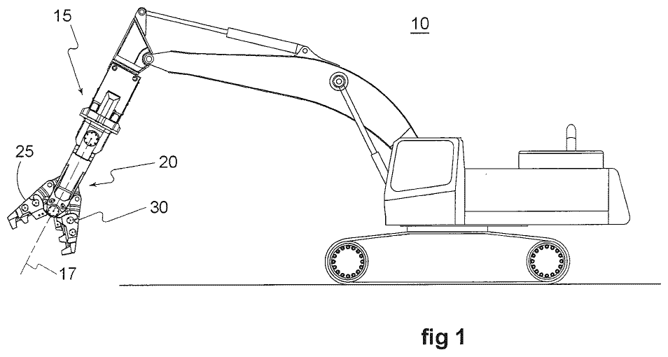

FIG. 1 illustrates an excavator 10 fitted with a boom 15 having a longitudinal axis 17. At the free end of the boom 15 is a jaw set 20 comprised of a first jaw 25 and a second jaw 30.

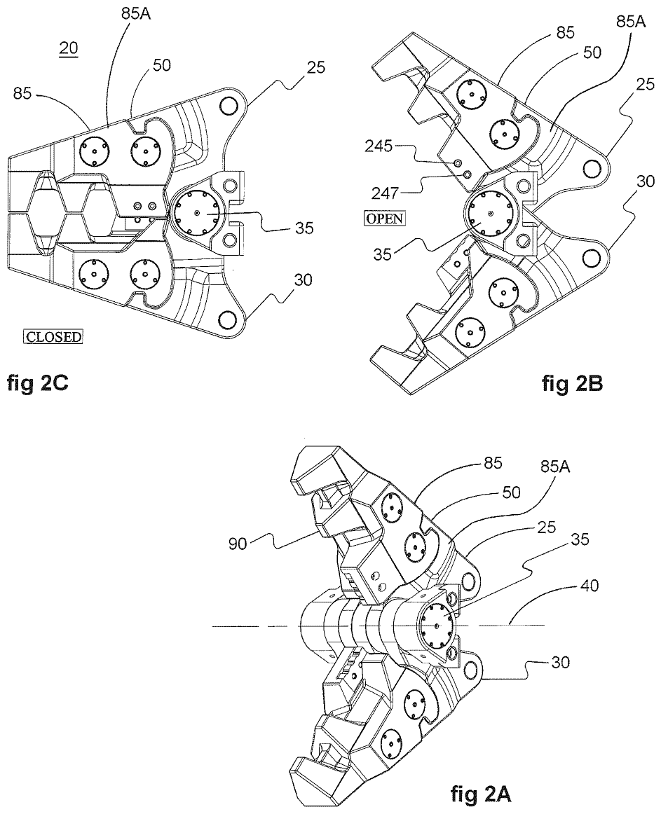

FIGS. 2A and 2B illustrate the jaw set 20 in FIG. 1 in a perspective view and a side view, while FIG. 2C illustrates the same jaw set 20 in a side view but in a closed position. The first jaw 25 is configured to be secured with a pivot pin 35 to the opposing second jaw 30 about a rotational axis 40. While what is described herein is an embodiment where the first jaw 25 and the second jaw 30 are secured by a common pivot pin 35, it is also possible for the first jaw 25 to rotate and for the second jaw 30 to be fixed. Furthermore, it is possible to space the first jaw 25 from the second jaw 30 so that each has their own pivot pin and furthermore to fix the second jaw 30 so that only the first jaw 25 rotates. In each of these arrangements, the first jaw 25 is secured to a pivot pin and adapted to allow relative rotation between the first jaw 25 and the second jaw 30.

The jaw set 20 illustrated in FIGS. 1 and 2A-2C is a concrete cracker 85A. However, as will be discussed, the subject invention allows for modification of the jaw set 20 to accommodate other demolition, recycling, and material processing equipment.

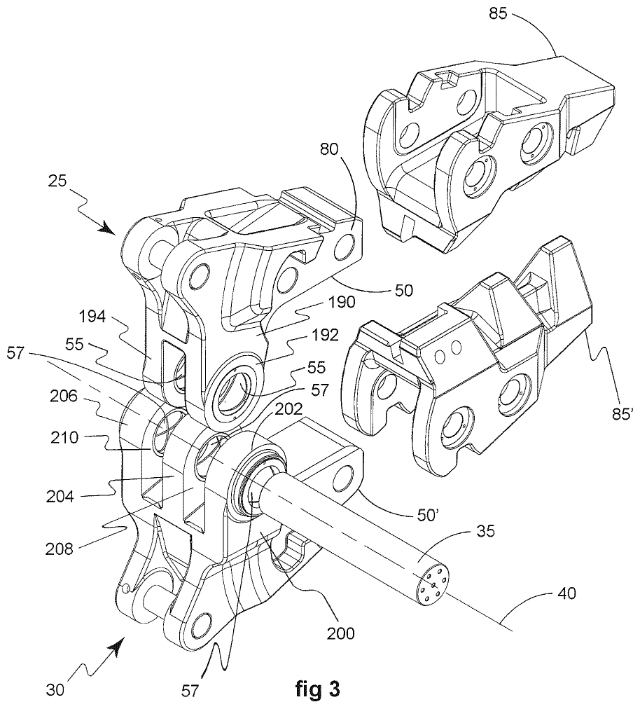

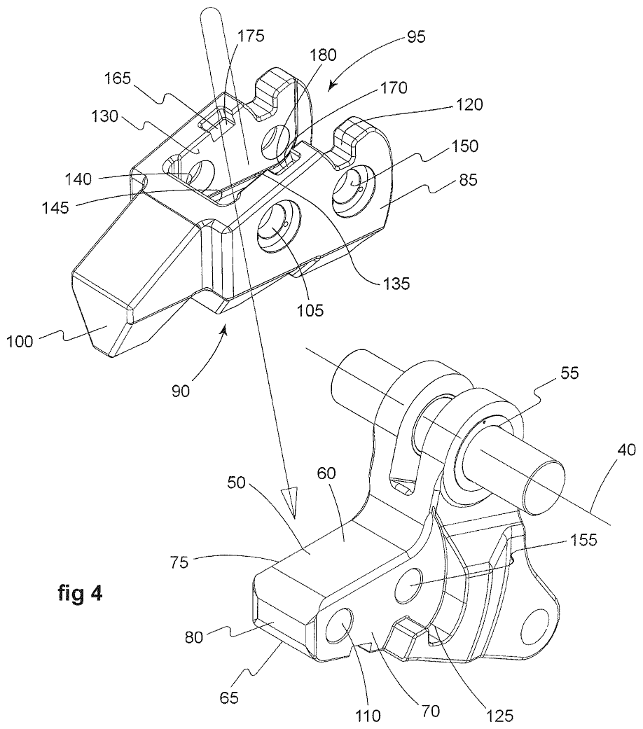

Directing attention to FIGS. 3 and 4, the first jaw 25 with the platform 50 has a bore 55 extending therethrough about the rotational axis 40. The platform 50 of the first jaw 25 extends away from a rotational axis 40 to define a first side 60, a second side 65, a first flank 70, and a second flank 75 opposite to the first flank 70. The first side 60 and the second side 65 are between the first flank 70 and the second flank 75. A front end 80 is defined by the intersection of the ends of the first side 60 and second side 65 and the first flank 70 and the second flank 75 furthest from the rotational axis 40.

As illustrated in FIGS. 2A-2C, a segment 85, or working shield 85, is secured to the platform 50 of the first jaw 25 and essentially protects the platform 50 and the remainder of the first jaw 25 from exposure to a workpiece upon which the jaw set 20 acts. As a result, the platform 50 and the remainder of the first jaw 25 covered by the segment 85 do not experience the wear and potential damage that may be inflicted by a workpiece. For the life of the jaw set 20, only the segment 85 must be replaced as the result of direct contact with the workpiece.

FIG. 3 illustrates the pivot pin 35 aligned with the bore 55 of the first jaw 25 and the bore 57 of the second jaw 30 extending through the first jaw 25 and the second jaw 30. As illustrated in FIG. 3, the pivot pin 35 pivotally secures the first jaw 25 to the second jaw 30. It should be noted that the pivot pin 35 uses a slip fit within the bores 55, 57 to make removal possible.

Directing attention to FIG. 4, the segment 85 has a working surface 90 for engaging a workpiece. The segment 85 has a cavity 95 with a shape complementary to the platform 50 of the first jaw 25. The segment 85 is received by the first flank 70 of the platform 50, the second flank 75 of the platform 50, substantially all of the first side 60 of the platform 50, and substantially all of the front end 80 of the platform 50 such that the platform 50 is shielded from substantially all direct engagement with the workpiece.

Furthermore, as can be seen in FIG. 4, the working surface 90 of the segment 85 may have a front end 100 that protrudes beyond the front end 80 of the platform 50.

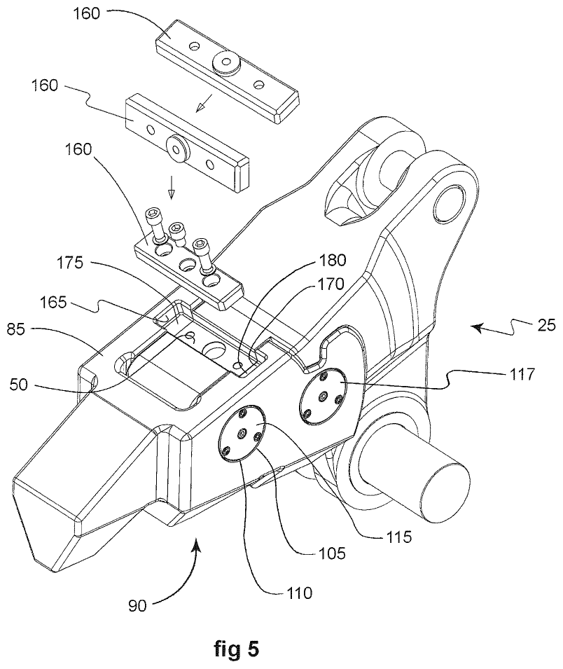

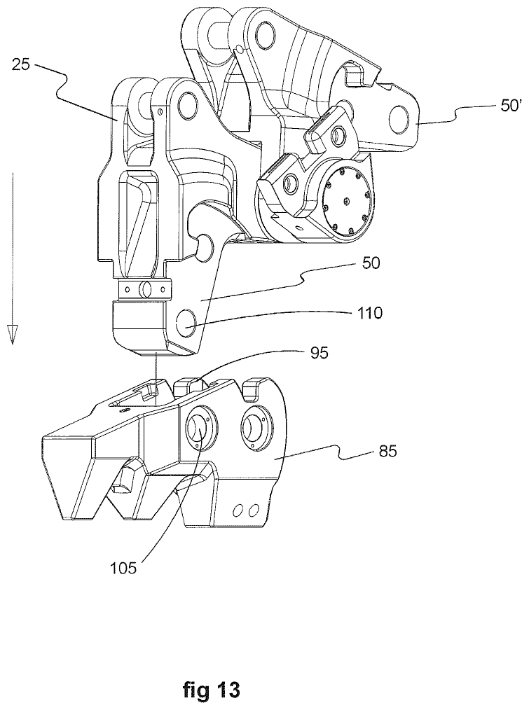

As further illustrated in FIG. 4 and FIG. 5 and in FIGS. 13-17, the segment 85 has a segment first bore 105 and the platform 50 of first jaw 25 has a platform first bore 110. With the segment 85 and the platform 50 mated, as illustrated, for example, in FIG. 5, the segment first bore 105 is coaxial with the platform first bore 110 to accept a first locking pin 115. The segment 85 pivots about the first locking pin 115 to engage with the platform 50. Furthermore, the platform 50 and the segment 85 are secured to one another when the segment 85 engages with the platform 50 as illustrated in FIG. 4 and the first locking pin 115 and a second locking pin 117 are secured within the segment bores 105, 150 and the platform bores 110, 155.

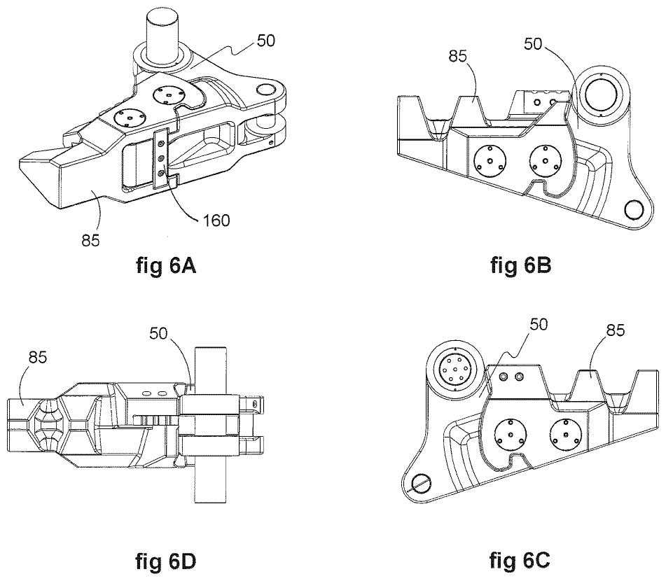

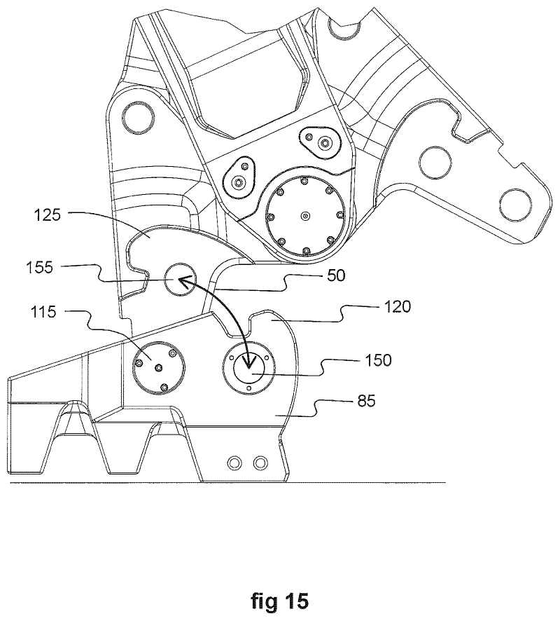

As further illustrated in FIG. 4, the segment 85 has a hook portion 120 and the platform 50 of the first jaw 25 has a complementary hook portion 125. When the segment 85 pivots about the first locking pin 115 within the first bore 105 of the segment 85 and the first bore 110 of the platform 50, the hook portions 120, 125 are engaged with one another (See also FIG. 15). FIGS. 6A-6D show additional views of the arrangement in FIG. 5 but with an alignment bar 160 secured.

FIG. 4 illustrates the segment 85 in an inverted position to reveal the cavity 95, which fits over the platform 50 of first jaw 25. The cavity 95 of the segment 85 has a first wall 130 and an opposing second wall 135. The cavity 95 of the segment 85 also has a front wall 140 and an inner wall 145 therebetween connecting the first wall 130 to the second wall 135.

Directing attention to FIG. 4 and FIG. 5 and FIGS. 13-17, the first bore 110 of the platform 50 of first jaw 25 aligns with the first bore 105 of the segment 85 and a first locking pin 115 is inserted therein. Furthermore, the segment 85 has a second bore 150 and the platform 50 has a second bore 155 which accepts a second locking pin 117 so that the segment 85 may be secured to the platform 50.

With the segment 85 secured to the platform 50 with the pins 115, 117 extending through the bores 150, 155, an alignment bar 160 may be used secured to the platform 50 to not only more closely align the segment 85 with the platform 50, but furthermore, the alignment bar 160 provides an additional level of integrity for the connection of the segment 85 to the platform 50.

In particular, directing attention to FIGS. 4 and 5, the first wall 130 of the segment 85 has a recess 165 and the second wall 135 of the segment 85 has an opposing recess 170. The alignment bar 160 is secured to the platform 50 and engages the recesses 165, 170 to limit the motion between the platform 50 and the segment 85.

FIG. 5 illustrates that the recess 165 of segment 85 has a floor 175, while the recess 170 has a floor 180, such that the alignment bar 160 secured to the platform 50 abuts against the floor 175 of recess 165 and against the floor 180 of recess 170 to secure the segment 85 against the platform 50.

This feature is particularly advantageous when separating the segment 85 from the platform 50 of the first jaw 25 because the alignment bar 160 retains the segment 85 to the platform 50 when the first locking pin 115 and the second locking pin 117 are removed.

Additionally, the tolerances for the engagement of the alignment bar 160 between platform 50 of the first jaw 25 and the segment 85 are less than those between the platform 50 and the segment 85 secured only with pins through the bores 105, 110 and 150, 155. As a result, the alignment bar 160 provides tighter tolerances to secure and align the segment 85 relative to the platform 50.

Returning to FIGS. 3 and 4, it is apparent that the segment 85 secured to the platform 50 receives and engages substantially all of the first side 60 of the platform 50, and substantially all of the front end 80 of the platform 50 along with the first flank 70 and the second flank 75 such that the platform 50 is shielded from substantially all direct engagement with a workpiece.

This provides a significant benefit to the prior art designs which do not completely protect the jaw from the workpiece. As a result, in the prior art designs, the workpieces are engaged not only by surfaces designed and intended to engage the workpiece, but furthermore the workpiece is engaged by other portions of the jaw that are unprotected and not intended to engage a workpiece. As a result, over time the jaw itself becomes worn and damaged, and must be reconditioned or replaced.

In accordance with the subject invention, the platform 50 is substantially protected by the segment 85 from the workpiece such that even after extensive operations, the platform 50 and the first jaw 25 associated with the platform 50 is exposed to minimum wear from the workpiece.

By doing so, wear is concentrated on the segment 85 such that the platform 50 and first jaw 25 are protected. As a result, the platform 50 and first jaw 25 have a much greater life expectancy than the prior designs where the equivalent of the platform or the jaw was exposed to the workpiece.

The platform 50 so far discussed, best illustrated in FIG. 3, is associated with the first jaw 25. Directing attention to FIG. 3, the second jaw 30 is essentially identical to first jaw 25 with the exception of the connection to the pivot pin 35.

The first jaw 25 has a base 190 with two legs 192, 194 spaced from one another. Each leg has a bore 55 extending therethrough such that the bore 55 is co-axial. The second jaw 30 has a base 200 with three legs 202, 204, 206 spaced from one another, each with a bore 57 extending therethrough such that the bore is co-axial. The legs 192, 194 of the first jaw 25 are positioned within slots 208, 210 between the legs 202, 204, 206 of the second jaw 30 such that the bore 50 and the bore 57 are aligned along a common rotational axis 40. Thereafter, the pivot pin 35 is secured within the bores 55, 57 to assemble the jaw set 20.

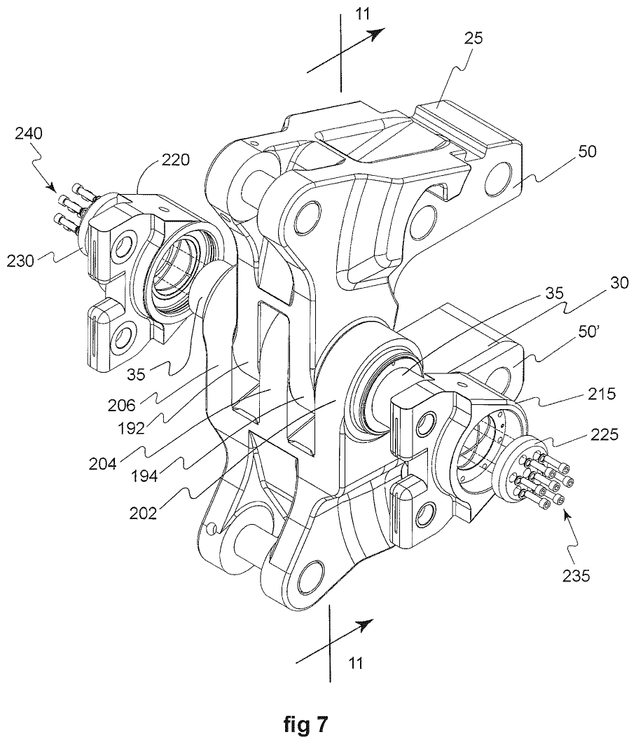

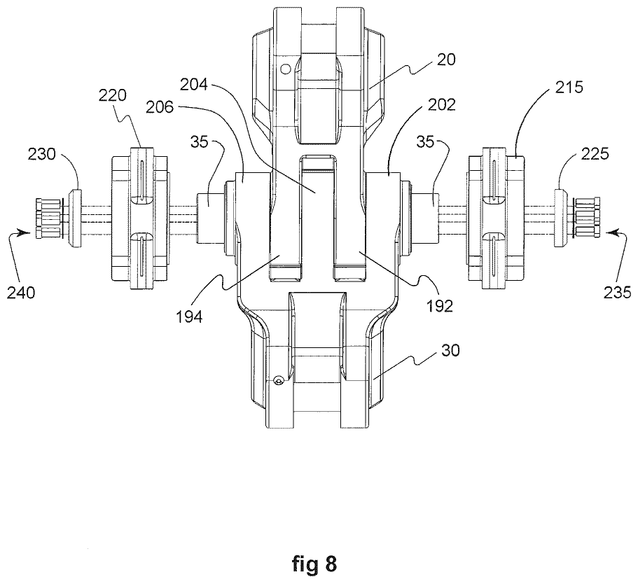

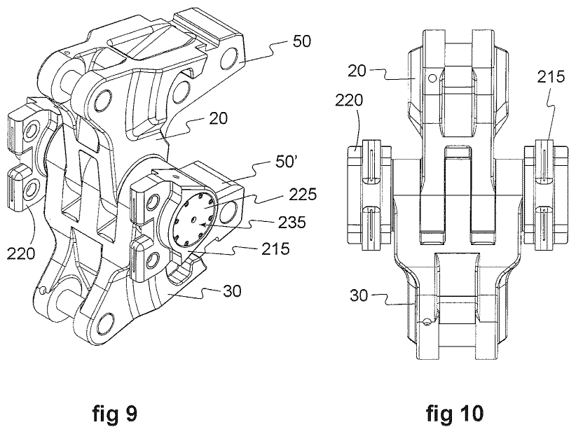

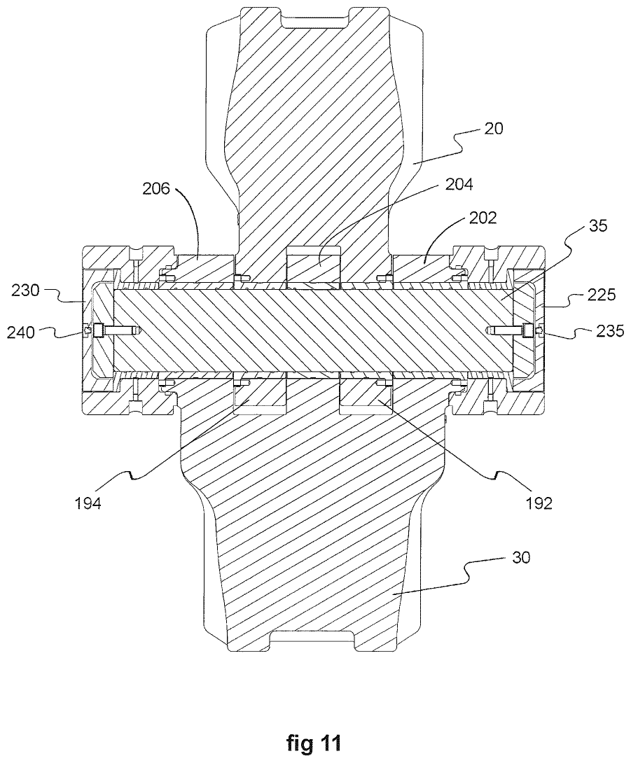

FIGS. 7-12 show additional features of the jaw set 20 assembly. As illustrated in FIG. 7, once the pivot pin 35 is inserted within the bores 55, 57 (not shown) of the legs 192, 194 of the first jaw 25 and legs 202, 204, 206 of the second jaw 30, then receivers 215, 220 are placed over each end of the pivot pin 35. The receivers 215, 220 are then each secured to the pivot pin 35 by plates 225, 230 and secured to the pivot pin with bolts 235, 240.

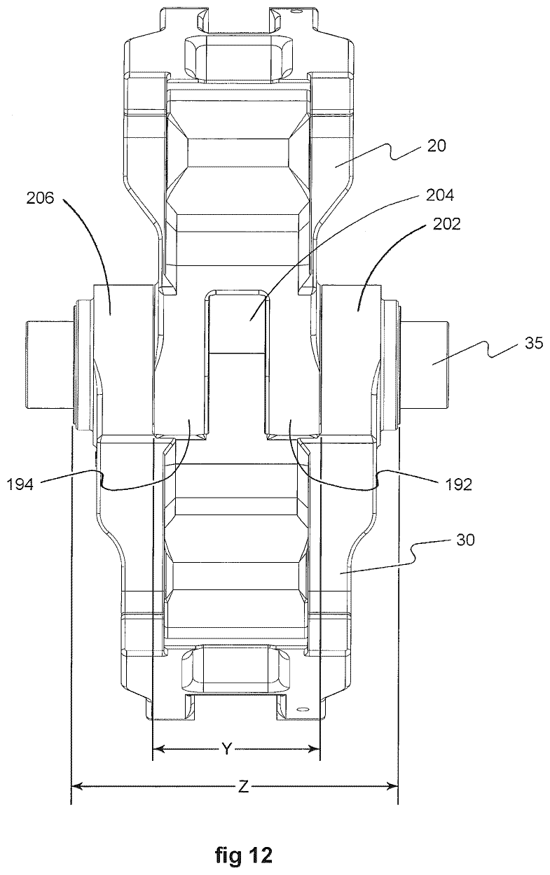

The jaw set 20 in accordance with FIGS. 7-12 provides greater structural integrity than those jaw sets with only a pair of legs extending from one jaw engaging with a single jaw from another jaw. In particular, directing attention to FIG. 12, for optimum support, the distance Y between the outer edges of the two legs 192, 194 of the first jaw 25 is at least 1/2 the distance Z between the outer edges of the two legs 202, 206 of the second jaw 30. Such an arrangement minimizes the deformation of the jaws 25, 30 under a torque loading.

Directing attention to FIGS. 2A-2C, the segment 85 associated with the first jaw 25 includes a blade 245 that is independently secured to the remainder of the segment 85 through bolts 247.

While the segment 85 may have more than one part, it is also possible for the segment 85 to have a unitary construction, whereby the entire working surface 90 is unitary and no additional attachments are provided. In particular, the segment 85 may be a single part.

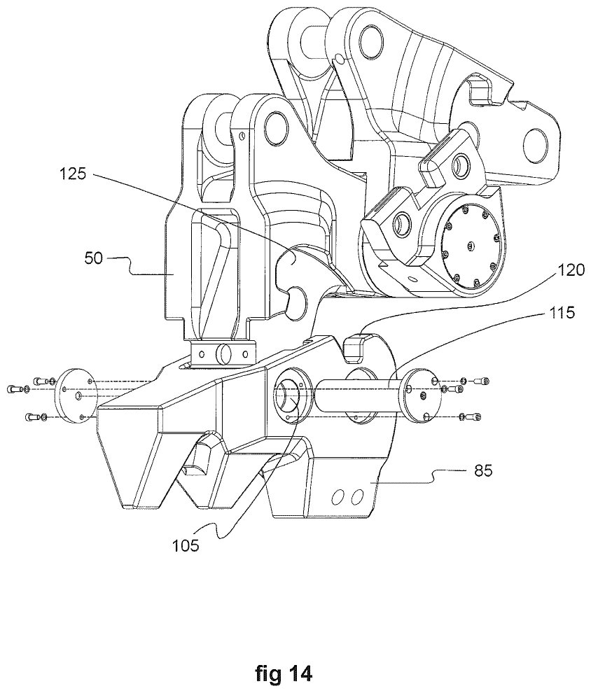

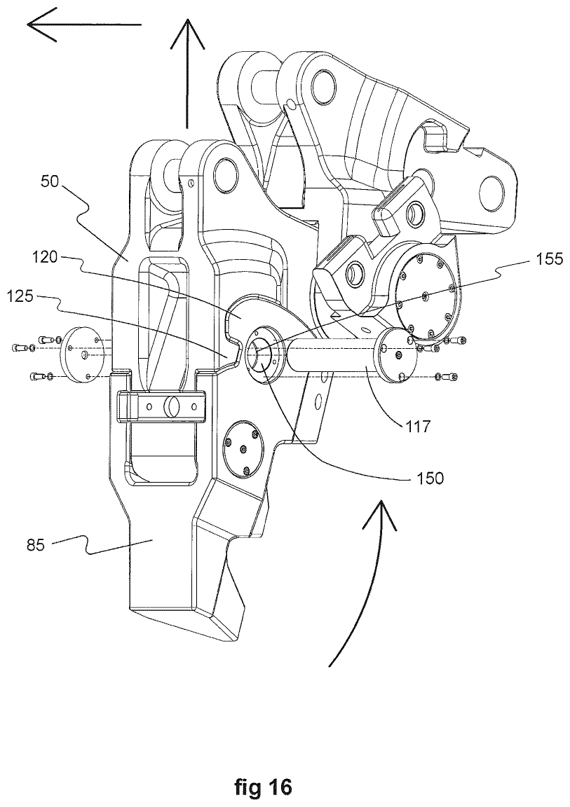

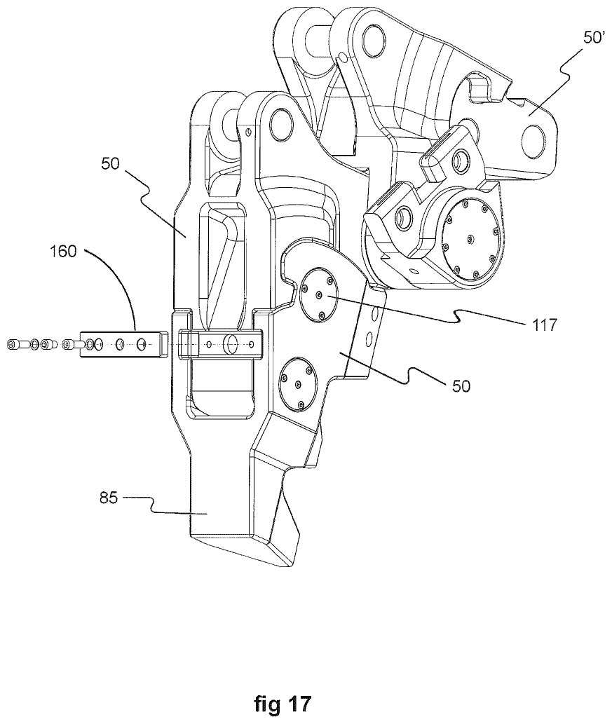

FIGS. 13-17 illustrate a method for securing a segment 85 onto a platform 50 of the first jaw 25 using the jaw set 20 illustrated in FIGS. 2A-2C. In particular, as illustrated in FIG. 13, the segment 85 is positioned in a stationary position with a cavity 95 exposed. The platform 50 is placed over the segment 85 and the platform 50 is moved into the cavity 95, so that the first bore 110 of the platform 50 aligns with the first bore 105 of the segment 85. Thereafter, as illustrated in FIG. 14, a first locking pin 115 is secured into the first bore 105 of the segment 85 and the first bore 110 of the platform 50 (FIG. 13). As further illustrated in FIG. 15, the platform 50 is then pivoted about the first locking pin 115 until the second bore 155 of the platform 50 aligns with the second bore 150 of the segment 85. As illustrated in FIG. 16, a second locking pin 117 is inserted and secured within the second bore 150 of the segment 85 and the second bore 155 of the platform 50. Note that the hook portions 120, 125 engage with one another. Thereafter, as illustrated in FIG. 17, the second locking pin 117 is secured to complete assembly of the segment 85 to the platform 50. To minimize tolerance between the platform 50 and the segment 85, an alignment bar 160 may be secured to the segment 85 and to the platform 50.

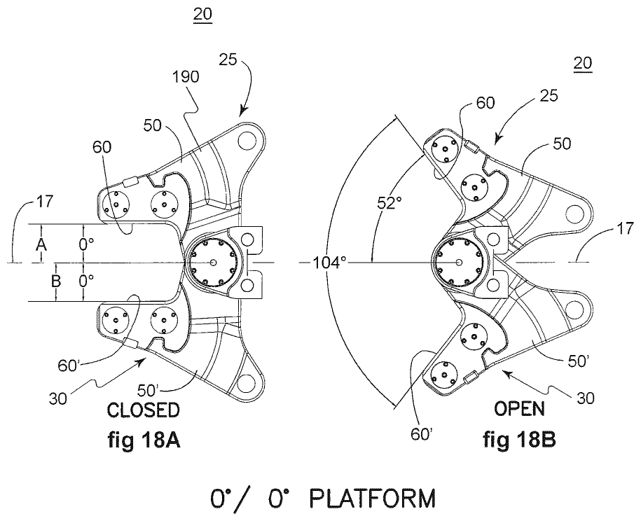

For convenience, when the second jaw 30 is discussed and an element of the second jaw 30 is similar to one of the first jaw 25, that element will be referred to with an “′”, such as platform 50 associated with the first jaw 25 and platform 50′ associated with jaw 30. The jaws 25, 30 may be fabricated for different configurations. Generally stated, and with respect to the jaw set 20 found in FIG. 18A, in the fully closed position of the jaw set 20, the first sides 60, 60′ of the platforms 50, 50′ of each jaw 25, 30 form an angle of 0° with one another. As illustrated in FIG. 18B, the jaws 25, 30 may be open to form an angle of 104° with one another. For identification, the platforms in FIGS. 18A and 18B will be described as 0° degree platforms. For reference, a neutral axis 17 of the boom 15 of FIG. 1 is included.

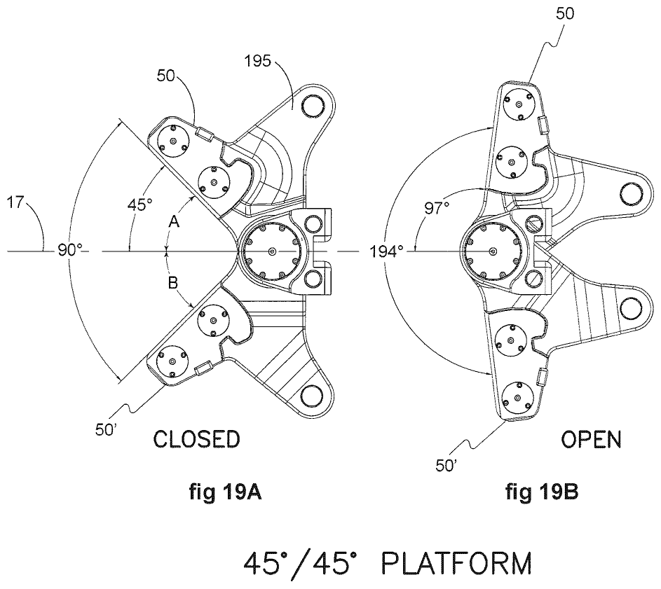

With respect to the jaw set 20 found in FIGS. 19A and 19B, from the fully opened position (FIG. 19B) to the fully closed position (FIG. 19A), there is a range of) 104° (194°-90°. For identification, the platforms 50, 50′ herein will be described as 45° degree platforms. From another perspective in the closed position, each of the platforms 50, 50′ form an angle A, B respectively of 45° with respect to the neutral axis 17.

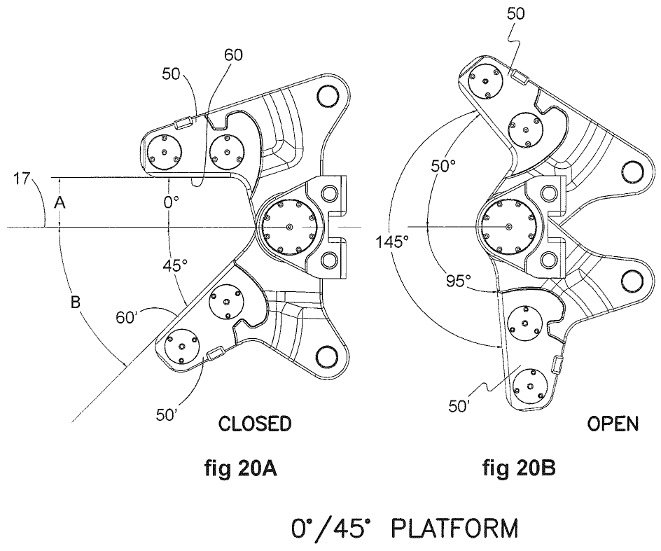

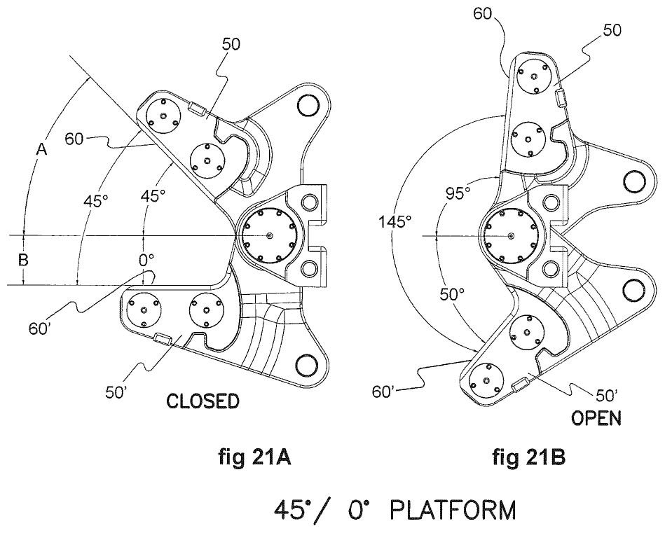

FIGS. 20A and 20B illustrate a jaw set 20 with a combination of a 0° platform 50 and a 45° platform 50′. As shown, the range of openings of the platform first sides 60, 60′ of the platforms 50, 50′ is 45° in the closed position and 145° in the open position. From another perspective, each platform 50, 50′ forms an angle A, B respectively of 45° with respect to the neutral axis 17. FIGS. 21A and 21B show an arrangement similar to 20A and 20B but with the platforms 50, 50′ reversed.

What has been described so far are platforms 50, 50′ with a segment 85 for use as a concrete cracker 85A. In particular, such a platform as part of a jaw set 20 is illustrated mounted to a boom 15 as shown in FIG. 1. FIG. 1 illustrates a jaw set 20 attached to the boom 15 of an excavator 10. For reference, a neutral axis 17 extends through the center of the boom 15 and through the coaxial bores 55, 57 of each of the first jaw 25 and the second jaw 30. Returning to FIGS. 18A and 18B, the first side 60 of platform 50 forms a first angle A with the neutral axis 17 and the first side 60. The first side 60′ of the other platform 50′ forms a second angle B with the neutral axis 17. The angles A and B are equal in FIGS. 18A and 18B. However, the platforms 50, 50′ may be different such that the first angle A and the second angle B form different angles as illustrated in FIGS. 20A and 20B and in FIGS. 21A and 21C.

While the segments 85 discussed so far with respect to FIGS. 2A-2C have been directed to a concrete crusher 85A, it should be appreciated that a major advantage of the subject invention is that the segment 85 may be fabricated to achieve any number of a variety of uses for demolition, recycling, or material processing equipment. For example, the following Figs. illustrate a platforms 50, 50′ similar to that discussed so far, but with a number of different segments 85 for different operations.

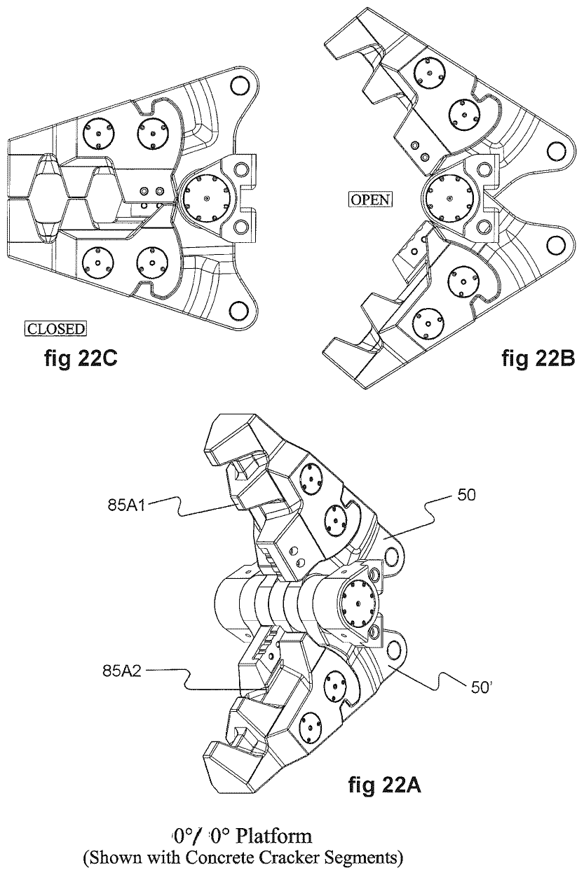

FIGS. 22A-22C illustrate platforms 50, 50′ with a segments 85A1 and 85A2 for use with a concrete cracker.

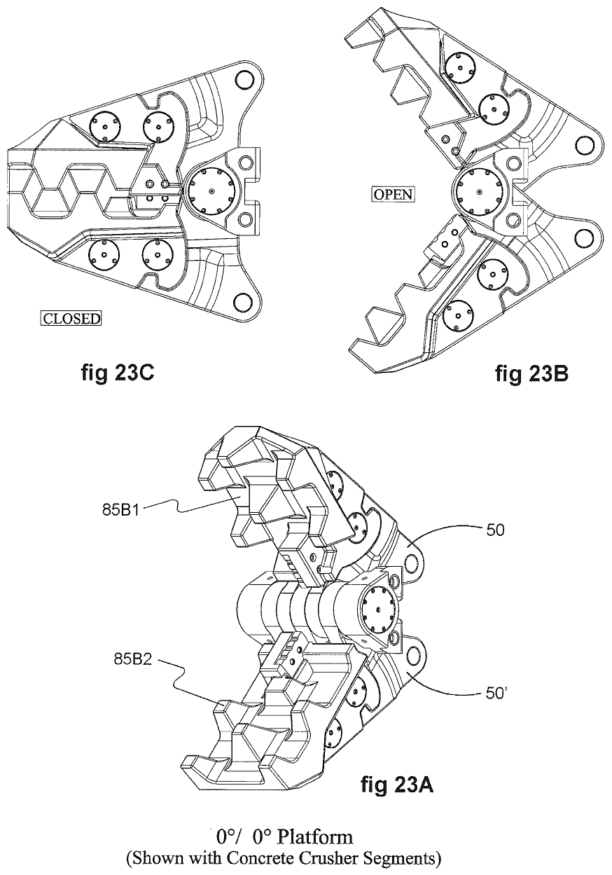

FIGS. 23A-23C illustrate platforms 50, 50′ with segments 85B1 and 85B2 directed to concrete crushing.

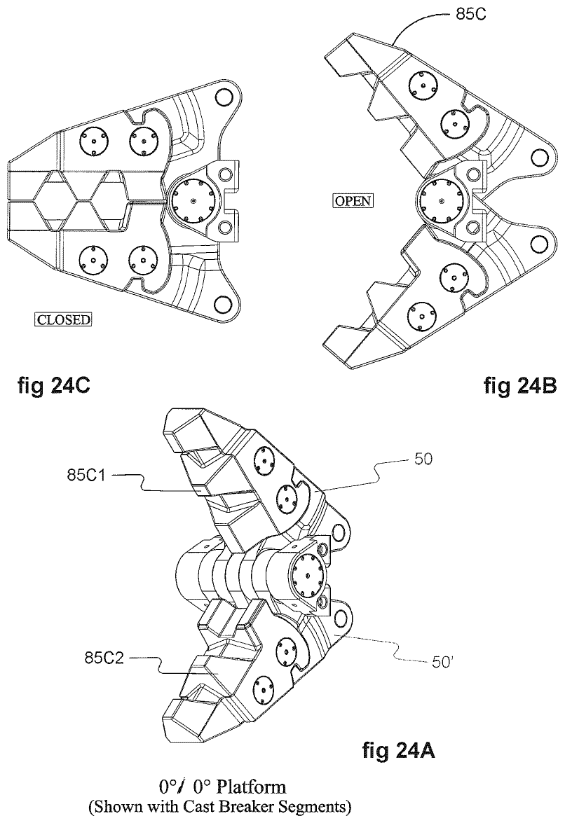

FIGS. 24A-24C illustrate platforms 50, 50′ with segments 85C1 and 85C2 directed for cast breaking.

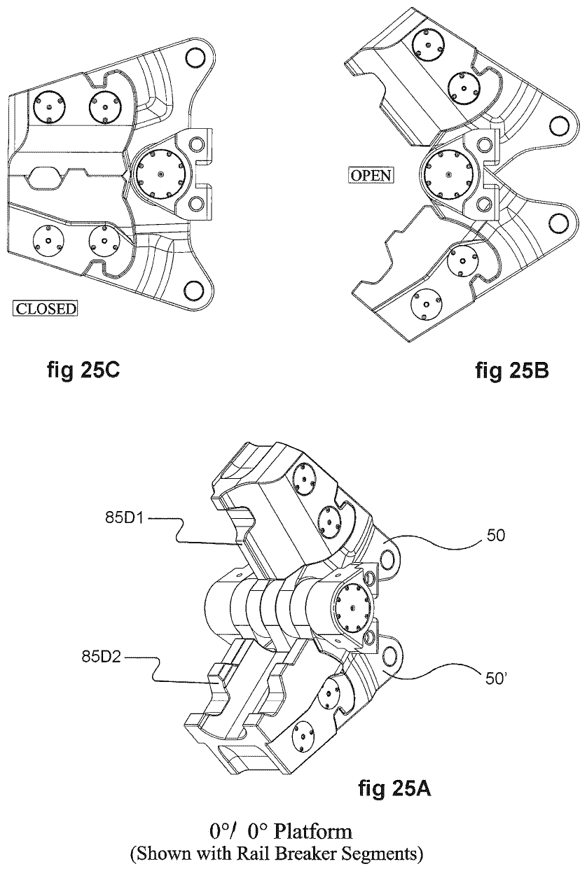

FIGS. 25A-25C illustrate platforms 50, 50′ with segments 85D1 and 85D2 directed to rail breaking.

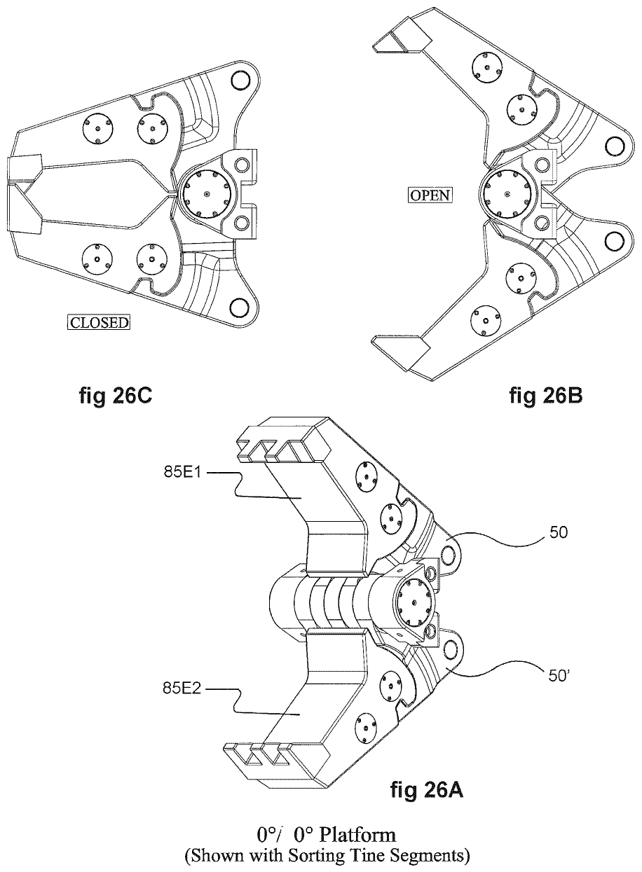

FIGS. 26A-26C illustrate platforms 50, 50′ with segments 85E1 and 85E2 acting as a sorting time.

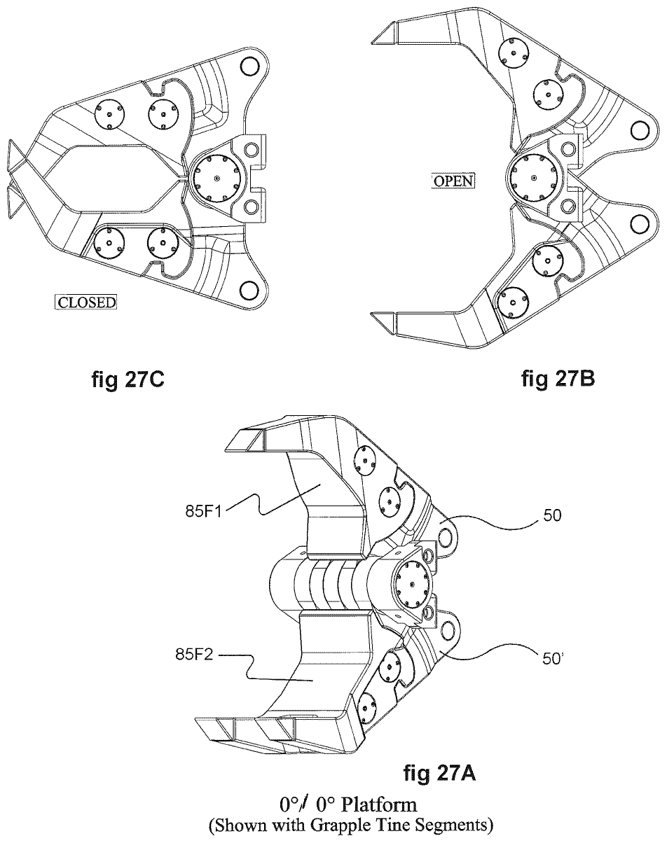

FIGS. 27A-27C illustrate platforms 50, 50′ with segments 85F1 and 85F2 directed to a grapple tine.

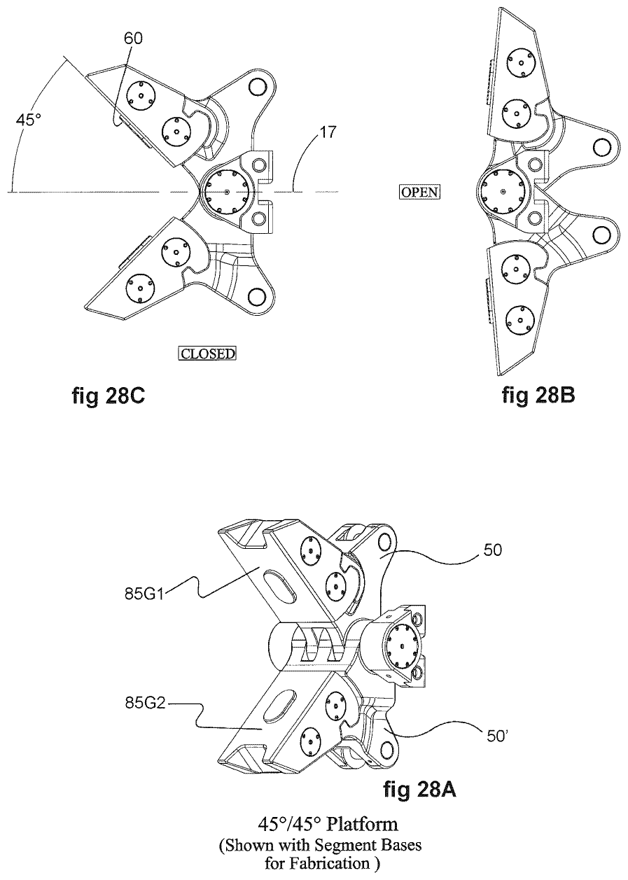

FIGS. 28A-28C illustrate platforms 50, 50′ with segments 85G1 and 85G2 which act as bases upon which to mount customized tools.

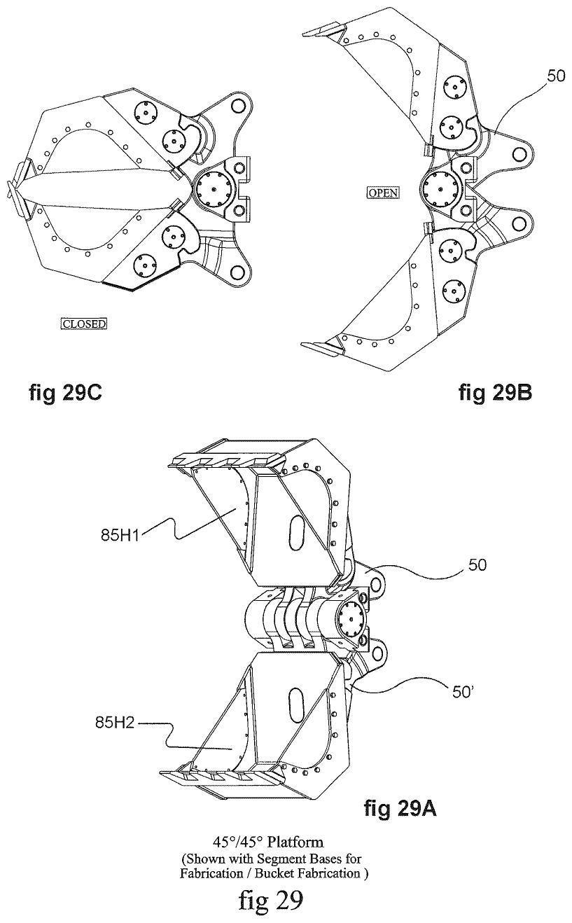

FIGS. 29A-29C illustrate a platform 50, 50′ with segments 85H1 and 85H2 to make up a bucket.

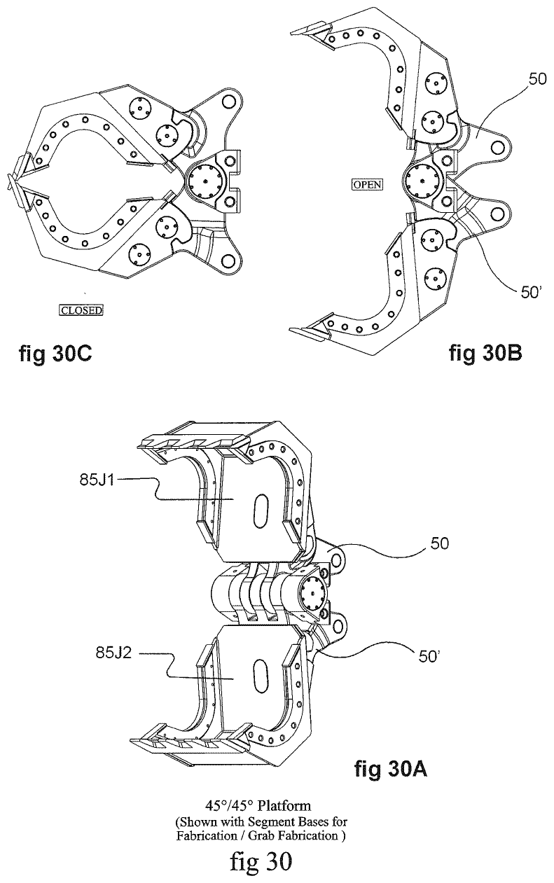

FIGS. 30A-30C illustrate platforms 50, 50′ with segments 85J1 and 85J2 for a grab.

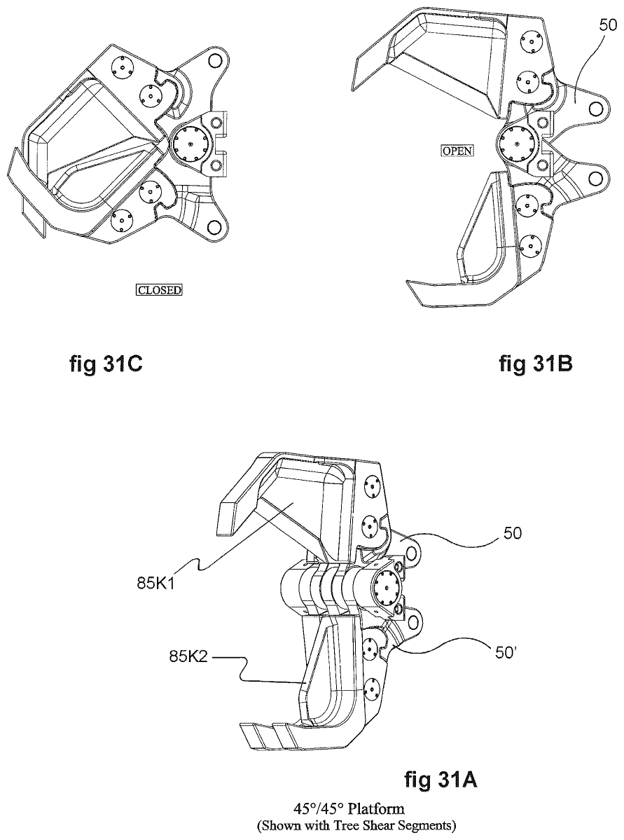

FIGS. 31A-31C illustrate platforms 50, 50′ with segments 85K1 and 85K2 for use as a tree shear.

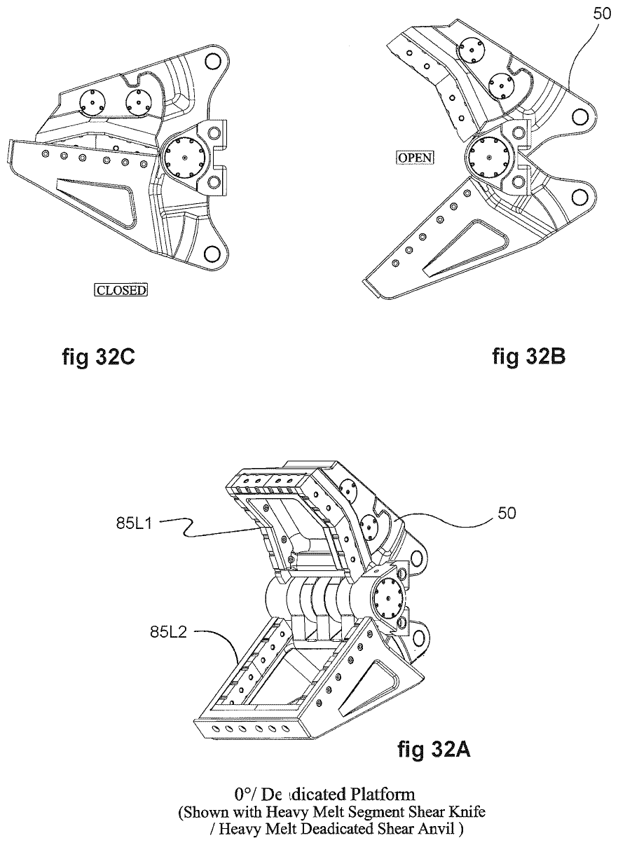

FIGS. 32A-32C illustrate platforms 50 having a removable segment 85L1 and a dedicated jaw with a fixed dedicated arrangement 85L2 directed to a heavy melt shear dedicated shear anvil.

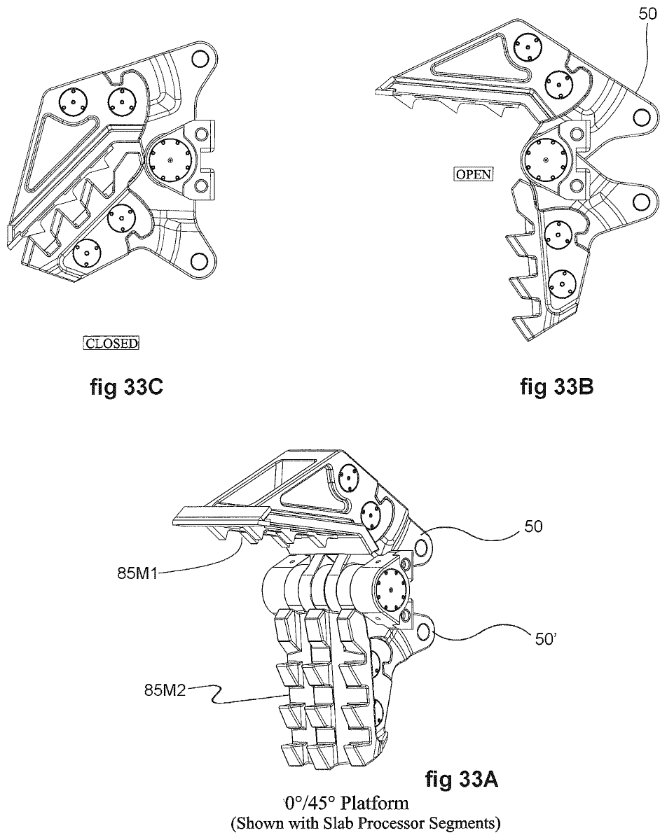

FIGS. 33A-33C are directed to platforms 50, 50′ having segments 85M1 and 85M2 for use as a slab processor.

As a result, the segment 85 of the platform 50 may be dedicated to particular demolition, recycling, or material processing equipment and may be comprised of a concrete crasher, a concrete cracker, a cast breaker or rail breaker, sorting tines, grapple tines, a bucket fabrication, a bucket grab, a tree shear, a slab processor, a heavy melt shear, and slab processor.

The segment 85 may be comprised of any number of working surfaces 90, while the segment 85 has the same cavity 95 for mating with the platform 50. Each different working surface 90 may be configured for a different demolition, recycling, or material processing operation.

It should be appreciated that an individual platform 50 may accommodate a number of different segments 85 as discussed herein. As an example, referring once again to the first jaw 25 of jaw set 20 illustrated in FIGS. 4 and 5, the platform 50 extends away from the rotational axis 40 to define a first side 60, a second side 65 opposite to the first side 60, a first flank 70, and a second flank 75 opposite to the first flank 70, wherein the first side 60 in the second side 65 are between the first flank 70 and the second flank 75. A front end 80 is defined by the ends of the sides 60, 65 and the flanks 70, 75 furthest from the rotational axis 40.

A kit may be provided for a jaw set 20, whereby the first and second jaws 25, 30 of platforms 50, 50′ are capable of accepting a number of different segments 85 to perform a number of different demolition, recycling, or material processing operations. By doing so, as previously mentioned, the segment 85 covers substantially all of the platform 50 surface that would otherwise be exposed to the workpiece. For all practical purposes, the platforms 50, 50′ are protected from the workpiece and do not encounter the wear and tear that they would otherwise experience. Furthermore, the segments 85 may be dedicated to particular operations, such that each segment 85 is optimized for that particular operation. Furthermore, if and when a segment 85 becomes worn or damaged, it is relatively easy to replace the segment 85.

While so far described is a single jaw, the subject invention may also be directed to a jaw set 20 as illustrated in FIGS. 2A-2C and FIG. 3, wherein the jaw set 20 has a first jaw 25 and a second jaw 30. The first jaw 25 is secured through coaxial bores 55 with the pivot pin 35 to the second jaw 30, such that at least one jaw 25, 30 rotates relative to the other jaw 25, 30 about a rotational axis 40. Each jaw 25, 30 is made up of a platform 50. The platform 50 extends away from the rotational axis 40. Each jaw 25, 30 further includes a segment 85 secured to the platform 50, wherein the segment 85 has working surfaces 90 for engaging a workpiece. Furthermore, each segment 85 has a cavity 95 (see FIG. 5) with a shape complementary to the platform 50. The segment 85 covers a substantial portion of the platform 50, such that the platform 50 is shielded from substantially all direct engagement with the workpiece.

As illustrated in FIG. 5, the first side 60 of the platform 50 may be substantially flat. As a result, the inner wall 145 of the segment 85 may also be substantially flat and complementary to the first side 60 of the platform 50.

To illustrate the versatility of such an arrangement, it should be appreciated that the platform 50 illustrated in FIGS. 30A-30C may have segments 85J1 and 85J2 to operate as a grab as illustrated in FIGS. 29A-29C. The very same platform 50, illustrated in FIGS. 31A-31C may accept segments 85K1 and 85K2 to operate as a tree shear. The variation may be as diverse as those shown in FIGS. 22A-22C through 33A-33C. As one example, cracker segments (FIGS. 22A-2C) may be replaced with grapple segments in FIGS. 27A-27C.

As a result, there is essentially no limitation to the variety of segments that may be attached to platforms in the subject invention.

Directing attention to FIGS. 20A-20B, the first side 60 of one platform 50 forms an angle A of 45° with the neutral axis 17, while the first side 60′ of the platform 50′ forms an angle B of 0° with the neutral axis 17.

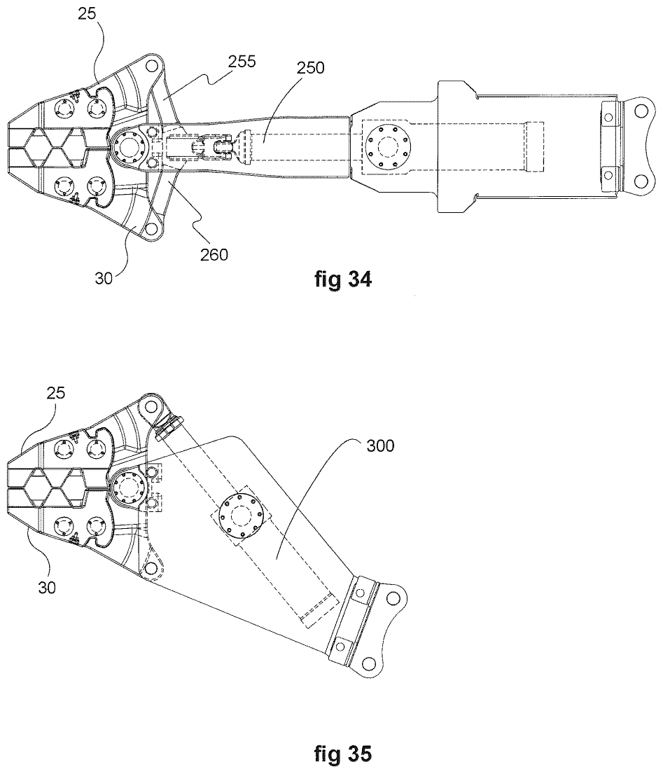

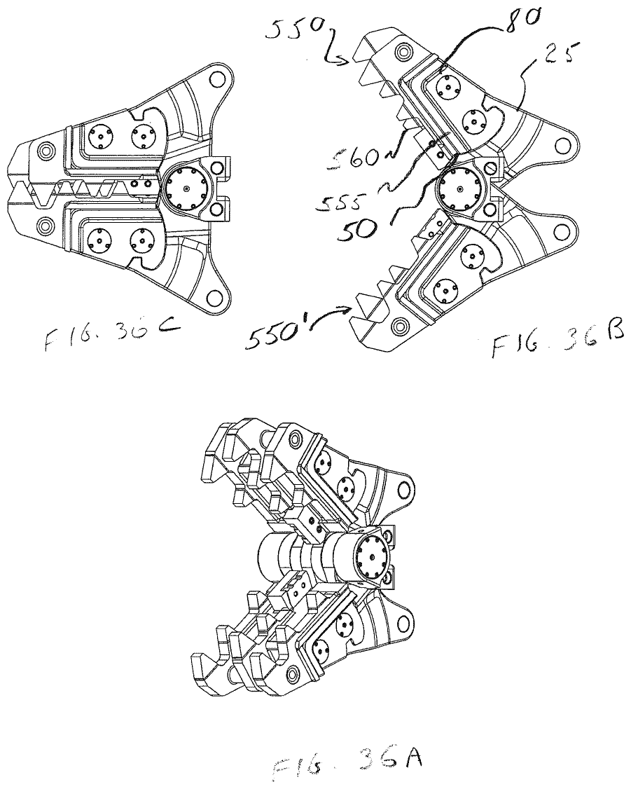

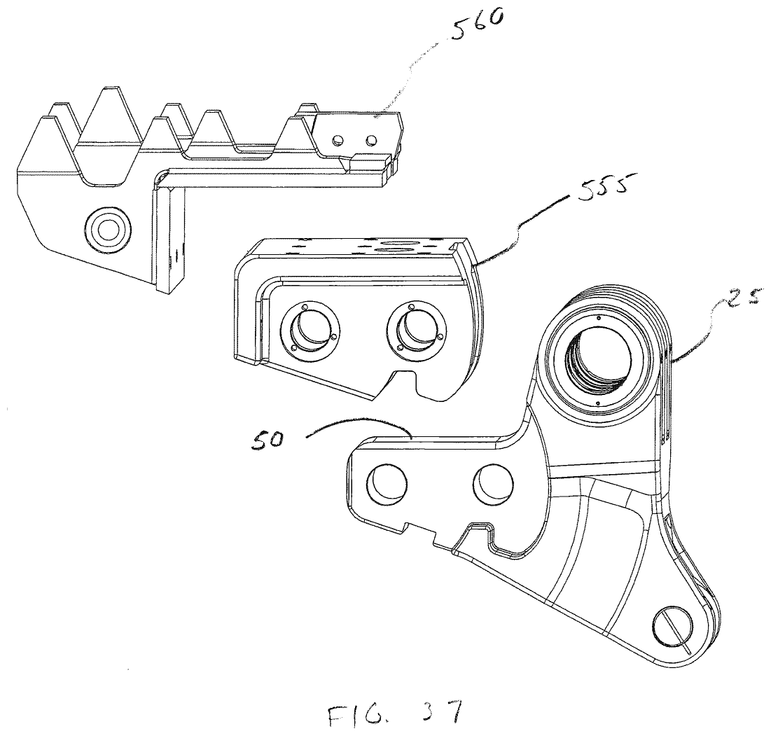

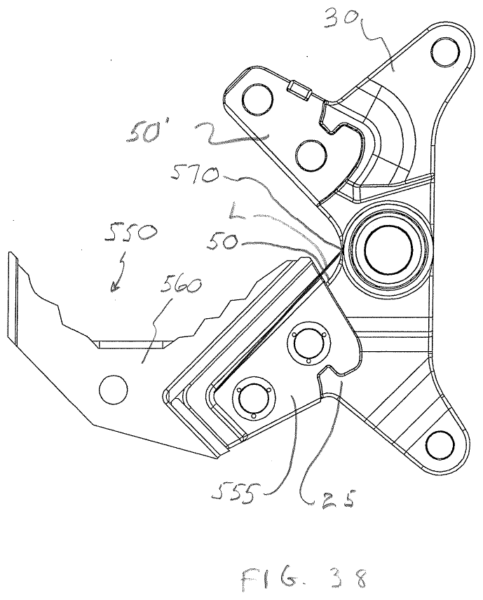

FIG. 34 shows the arrangement similar to that in FIG. 1 wherein a single hydraulic cylinder 250 rotates the two jaws 25, 30, which may be performed using two linkages 255, 260. It is also possible to utilize two separate cylinders wherein each cylinder rotates a jaw 25, 30. In the alternative, as illustrated in FIG. 35, it is possible for a single cylinder 300 to operate only a single jaw 25 while the opposing jaw 30 remains stationary.

It is also possible to have a jaw set 20 wherein the bores 55, 57 through each jaw 25, 30 are spaced apart such that the first jaw 25 and the second jaw 30 are adapted to allow relative rotation between the first jaw 25 and the second jaw 30. Finally, it is possible to have a jaw set 20 wherein one jaw 25 pivots about a bore 55 and the second jaw 30 is fixed but spaced from the first jaw 25 such that there is relative rotation between the jaws 25, 30, although not about a common pivot. In each of these arrangements, the first jaw 25 is secured with a pivot pin 35 and adapted to allow relative rotation between the first jaw 25 and the second jaw 30.

Directing attention to FIGS. 3 and 4, what has so far been described is a segment 85 matable with a platform 50 wherein the segment 85 is made up of the working surface 90 and a cavity 95 defined by a first wall 130, a second wall 135, a front wall 140, and an inner wall 145. The segment 85 is a unit that is placed over the platform 50 of the first jaw 25. It is noted that the segment 85 as shown in FIGS. 3 and 4 may be a single piece.

Directing attention to FIGS. 23A-23C, such a segment 85B1 is shown attached to the platform 50 of the first jaw 25. It is possible that the segment 50 so far described as a unitary part may be made of more than one part.

Directing attention to FIGS. 36A-C, a similar tool shown to that shown in FIGS. 23A-23C is illustrated. However, upon closer inspection it is noted that, as opposed to the working shield 85B1 in FIGS. 23A-23C, the working shield 550 in FIGS. 36A-36C may be made up of a base 555 secured to the jaw 25 and a separate segment shell 560 secured to the base 555.

By providing such an arrangement the cost for customers is reduced because a single base 555 may be purchased and used with multiple types of segment shell 560.

It should be noted that the function of the combined base 555 and segment shell 560 illustrated in FIGS. 36A-36C perform substantially identically to the arrangement illustrated in FIGS. 23A-23C. But for the introduction of two separate parts, which are the base 555 and the segment shell 560, the function and operation of each of the arrangements are essentially identical.

As previously discussed, one of the goals of the subject invention is to protect the platform 50 of the first jaw 25 from exposure to and damage caused by engagement with the workpiece during operation. This goal is still achieved with the current arrangement. It should be appreciated that while the discussion is directed to the first jaw 25, the same discussion also applies to the second jaw 30. When similar elements of the second jaw 30 are discussed, they will be referred to with an “′”, such as 80 and 80′.

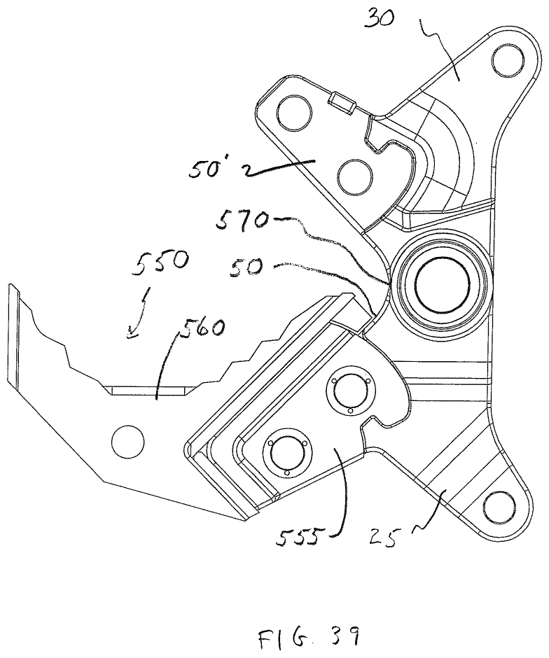

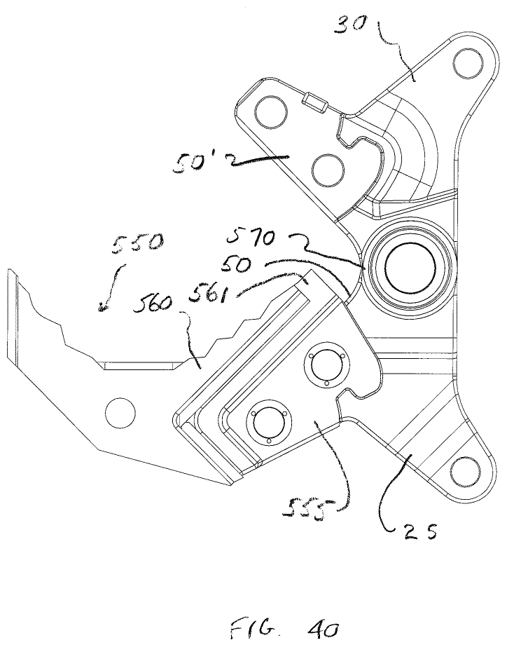

Directing attention to FIG. 37, it can be appreciated that the base 555, when placed over the platform 50, protects nearly the entire platform 50. While it is apparent that the segment shell 560 directly engages with the work piece, in this arrangement the base 555 is the part that covers and protects the platform 50 of the first jaw 25. In this embodiment, the segment shell 560 covers only the upper surface of the base 555.

This protection of the platform 50 by the base 555 may also be supplemented by the segment shell 560.

Briefly returning to FIG. 3, the segment (working shield 550) 85 was comprised only of a single piece segment 85.

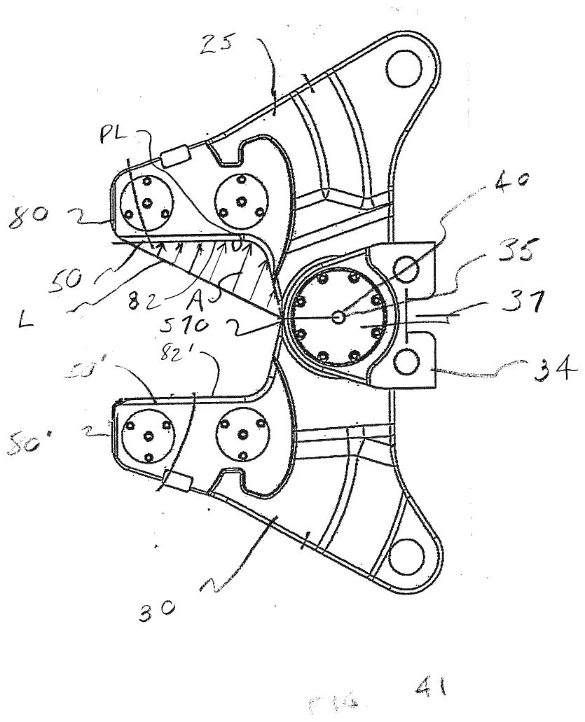

Directing attention to FIGS. 38-40, the working shield 550 is now comprised of a base 555 and segment shell 560, wherein the base 555 is secured to the jaw 25 and the segment shell 560 is secured to the base 555. In FIGS. 38 and 39, only the segment shell 560 that provides the working surface 550 and the segment shell 560 completely covers the base 555. It should be noted that, for convenience, the lower jaw is referred to as the first jaw 25 in FIGS. 38-40.

Directing attention to FIG. 39, it is apparent that the segment shell 560 extends beyond the base 555 in the direction of the throat 570 and the segment shell 560 contributes to protecting the platform 50.

Directing attention to FIG. 40, in yet another embodiment, the segment shell 560 and the base 555 together provide the working shield 550. However, the segment shell 560 extends along a portion of the platform 50 and the base 555 extends over an adjacent portion of the platform 50 in the direction of the throat 570 such that it is a combination of the segment shell 560 and the base 555 that protect the platform 50. This additional protection provided by the base 555 is seen by the tab 561 extending from the base 555.

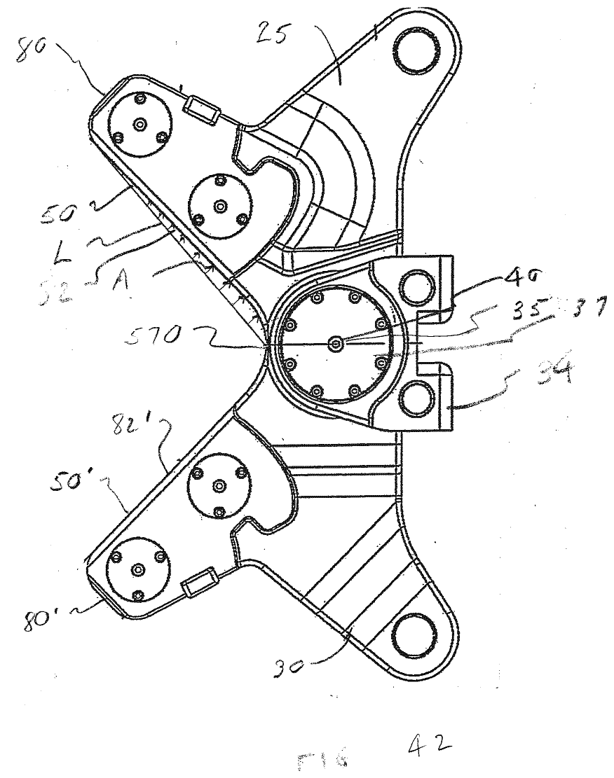

FIG. 41 illustrates a 0 degree jaw set in a closed position. A 0 degree jaw is defined by the orientation of the platform 50 relative to the axis 17 of the boom 20 (FIG. 1) to which the jaw is mounted.

The jaw set has a first jaw 25 and a second jaw 30. The first jaw 25 is configured to be secured to a receiver 34 with a pivot pin 35 having a rotational axis 40 comprising a pivot group 37 and adapted to allow relative rotation between the first jaw 25 and the second jaw 30. A platform 50 on the first jaw 25 has a front end 80 and an inner surface 82. A platform 50′ on the second jaw 25 has a front end 80′ and an inner surface 82′. A throat 570 is defined by the overlapping portion of the two jaws 25, 30 along the inner surfaces 82, 82′ at a point closest to the pivot group 37.

It is well known to those skilled in the art that the pivot group 37 is made up of a pivot shaft (or pivot pin), bearings associated with the pivot shaft (or pivot pin), and an outer housing containing these components.

FIG. 41, as mentioned, illustrates a first jaw 25 with a platform 50. The platform 50 extends from the front end 80 of the jaw 25 to the throat 570.

In order to determine the coverage provided to the platform 50 by the working shield 550, a platform length PL is defined by a perpendicular projection from a line L extending from the front end 80 of the jaw 25 to the throat 570. As illustrated in FIG. 41, the arrows A projected from the line L intersect with the platform 50. In this manner the coverage of the platform 50 provided by the working shield 550 may be measured.

While the front end 80 of the jaw 25 may be covered by the working shield 550, the measurement along the platform length PL is directed to coverage of the inner surface of the platform 50.

Briefly returning to FIG. 38, the line L has been introduced and extends through the working shield 550 to give an idea of how the line L is used to address the coverage that the working shield 550 provides to the platform 50.

Returning to FIG. 41, in one embodiment, the working shield 550 extends along at least 50% of the line L to illustrate coverage of the platform 50. In another embodiment, the working shield 550 extends along at least 70% of the line L to illustrate coverage of the platform 50. In yet another embodiment, the working shield 550 extends along at least 90% of the line L to illustrate coverage of the platform 50.

FIG. 42 illustrates a 45 degree jaw set in a closed position. A 45 degree jaw is defined by the orientation of the platform 50 relative to the axis 17 of the boom 20 (FIG. 1) to which the jaw is mounted. The jaw set has a first jaw 25 and a second jaw 30. The first jaw 25 is configured to be secured to a receiver 34 with a pivot pin 35 with a rotational axis 40 comprising a pivot group 37 and adapted to allow relative rotation between the first jaw 25 and the second jaw 30. A platform 50 on the first jaw 25 has a front end 80 and an inner surface 82. A platform 50′ on the second jaw 25 has a front end 80′ and an inner surface 82′. A throat 570 is defined by the overlapping portion of the two jaws 25, 30 along the inner surfaces 82, 82′ at a point closest to the pivot group 37. The measurements for coverage of the platform length PL are identical to those just discussed with respect to FIG. 41. Similar reference numbers have been added for ease of understanding.

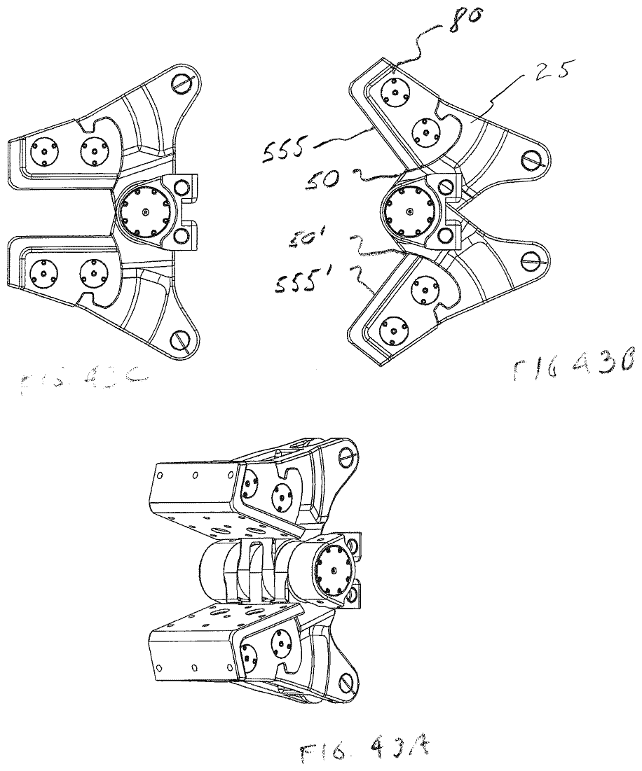

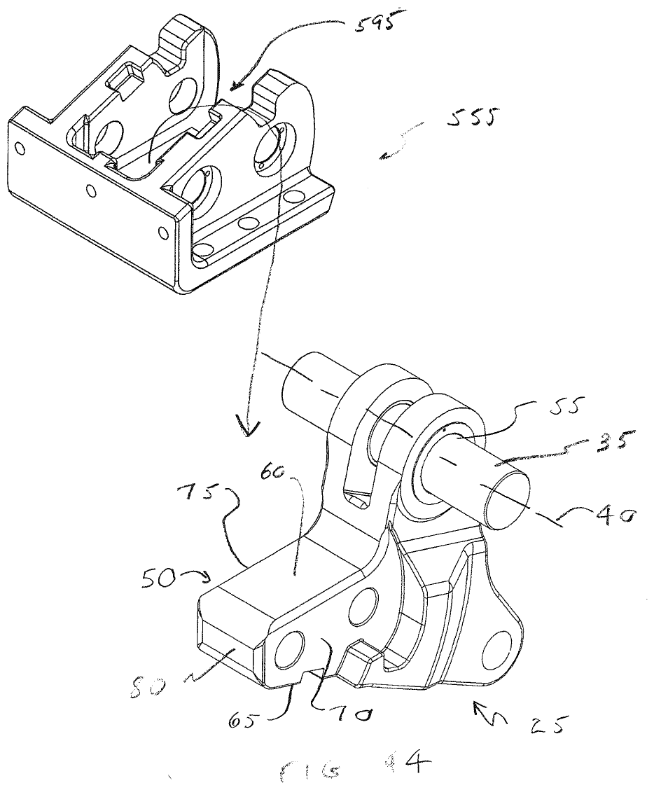

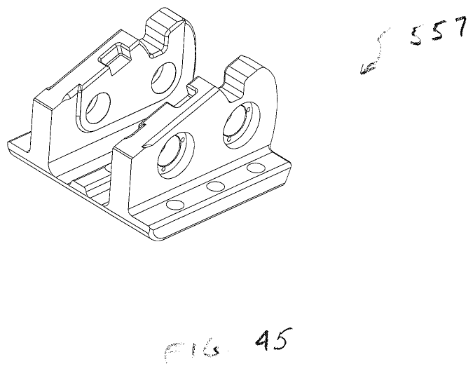

FIGS. 43A-43C and FIG. 44 illustrate a jaw set by which only the base 555 is secured to the platform 50. It should be appreciated in this embodiment the base 555 covers the front end 80 of the jaw 25. It will be noted that this design is in contrast to another design illustrated in FIG. 45 wherein the base 555 has an open end such that when the base 555 is mounted to the jaw 25, the front and 80 of the platform 50 is not covered.

Although the platform 50 is identical throughout the embodiments, attention will be directed to FIG. 44. The first jaw 25 with the platform 50 has a bore 55 extending therethrough about a rotational axis 40 to accept a pivot pin 35. The platform 50 extends away from the rotational axis 40 to define a first side 60, a second side 65 opposite to the first side 60, a first flank 70, and a second flank 75 opposite to the first flank 70. The first side 60 and the second side 65 are between the first flank 70 and the second flank 75. A front end 80 is defined by the intersection of the ends of the first side 60 and the second side 65 and the first flank 70 and the second flank 75 furthest from the rotational axis 40.

It should be noted that the base 555 in FIG. 44 is inverted so the details may be described. However, for assembly the base 555 is rotated such that the cavity 595 fits over the platform 50.

While FIG. 44 illustrates only the base 555 it should be appreciated that the geometry of the base 555 when coupled with the segment shell 560 form the working shield 550 (FIG. 37) and resemble the segment 85 illustrated in FIG. 4. The working shield 550 may be either the segment 85 alone (FIG. 4) or the combination of the base 555 and the segment shell 560 (FIG. 37). For that reason, the base 555 will be described in light of that similarity. The base 555 has a cavity 595 with a shape complementary to the platform 50. As a result, the base 555 is received by the first flank 70 of the platform 50, the second flank 75 of the platform 50, the first side 60 of the platform 50, the front end 80 of the platform 50 such that the platform 50 is shielded from direct engagement with the work piece. The working shields 85, 550 cover portions of the platform 50 that experience compressive forces when the jaws are moved against a workpiece from a jaw open position to a jaw closed position.

As previously discussed, the base 555, as illustrated in FIG. 45, may not have a front end such that, when mounted upon the jaw 25, the front end 80 of the platform 50 would not be covered. Just as the base 555 in FIG. 44 must be inverted to mate with the jaw 25, so too must the bade 557. Under these conditions, the platform front end 80 (FIG. 44) will not be covered.

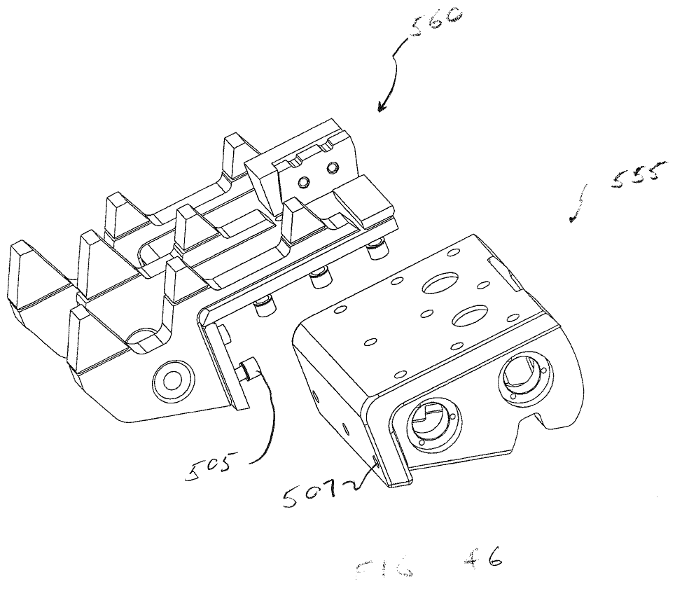

Briefly returning to FIGS. 36A-36C, it is clear that the working shield 550 may protrude beyond the front and 80 of the platform 50. This would be further apparent from an inspection of FIG. 46 where the base 555 in the segment shell 560 when combined and mounted upon the jaw 25 would clearly protrude beyond the front end 80 of the platforms 50, 50′.

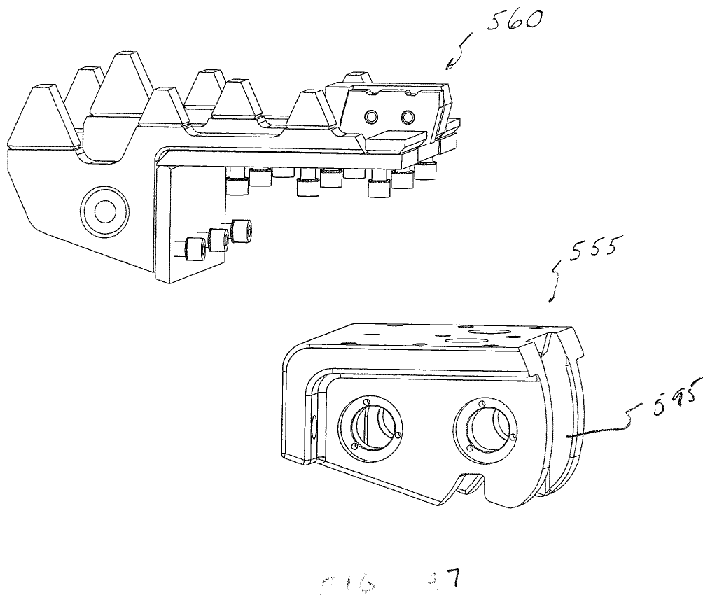

FIGS. 46-48 illustrate how the segment shell 560 is secured to the base 555. A plurality of bolts 505 pass through bores 507 extending through the base 555 and engage the segment shell 560 to secure the base 555 to the segment shell 560. As a result, the combined base 555 and segment shell 560 resembles the configuration of the segment shell 560 in FIGS. 36A-36C.

The manner by which the base 555 is secured to the jaw 25 is identical to the manner by which the segment 85 is secured to the platform 50 as illustrated in FIGS. 13-17 with the associated discussion. This includes the use of the alignment bar 160 (FIG. 17).

Just as with respect to the segment 85, the working shield 550, on each jaw 25, 30 is dedicated to a particular demolition, recycling, or material processing operation and is comprised of a dedicated tool part from comprised of from the group comprised of a concrete crusher, a concrete cracker, a cast breaker, or rail breaker, sorting tines, grapple tines, a bucket fabrication, a bucket grab, a tree shear, a slab processor, a heavy melt segment shear, and a heavy melt shear.

While with respect to FIGS. 13-17, the cavity 95 is described with respect to the segment 85. The cavity 595, like cavity 95 has identical features but these features are now associated with the base 555.

While FIGS. 46-48 show how the segment shell 560 is secured to the base 555, FIG. 49 shows how the segment shell 560, the base 555 and the platform 50 of the jaw 25 fit together. The base 555 is secured to the jaw 25 in the same fashion as that described with respect to the segment 85 secured to the jaw 25 illustrated in FIGS. 13-17.

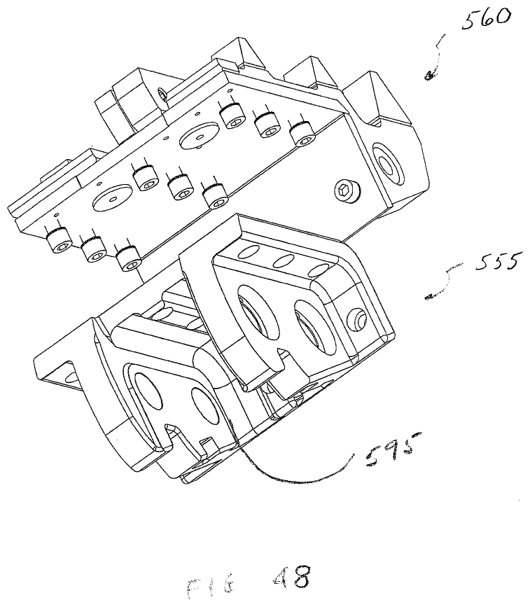

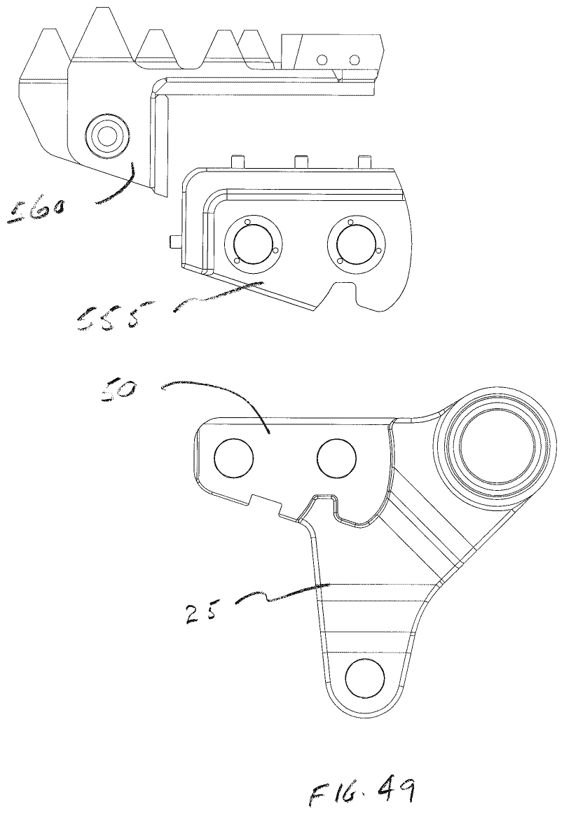

FIGS. 50A-50C illustrate a bucket with platforms 50, 50′ and segment shields 550N1, 550N2;

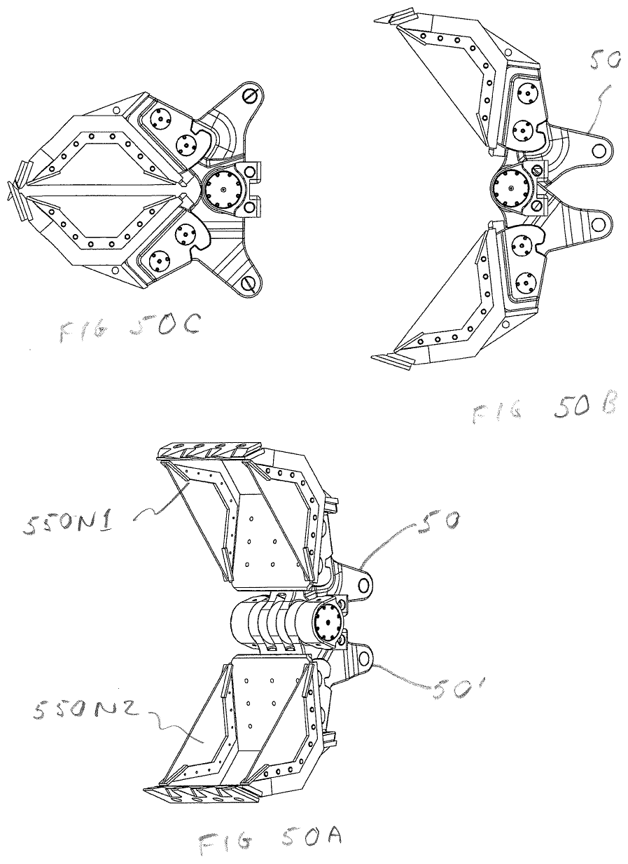

FIGS. 51A-51C illustrate a log sheer with platforms 50, 50′ and segment shields 550P1, 550P2;

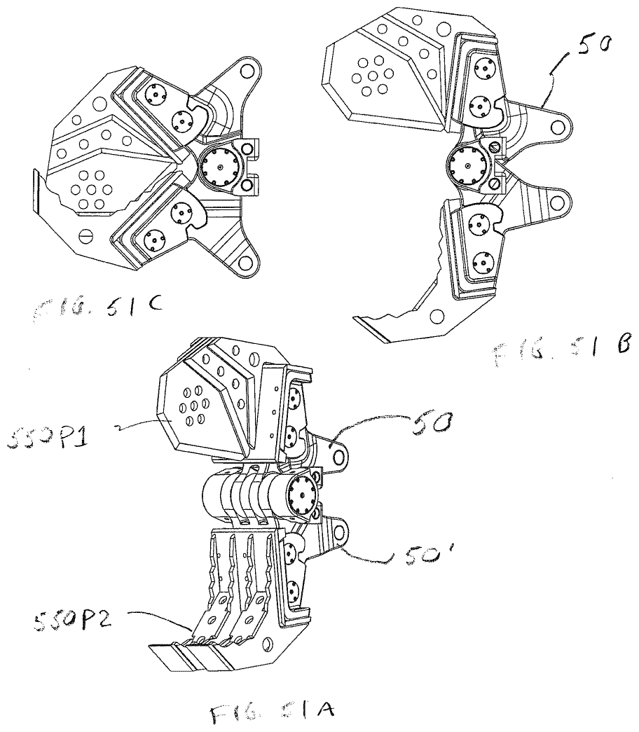

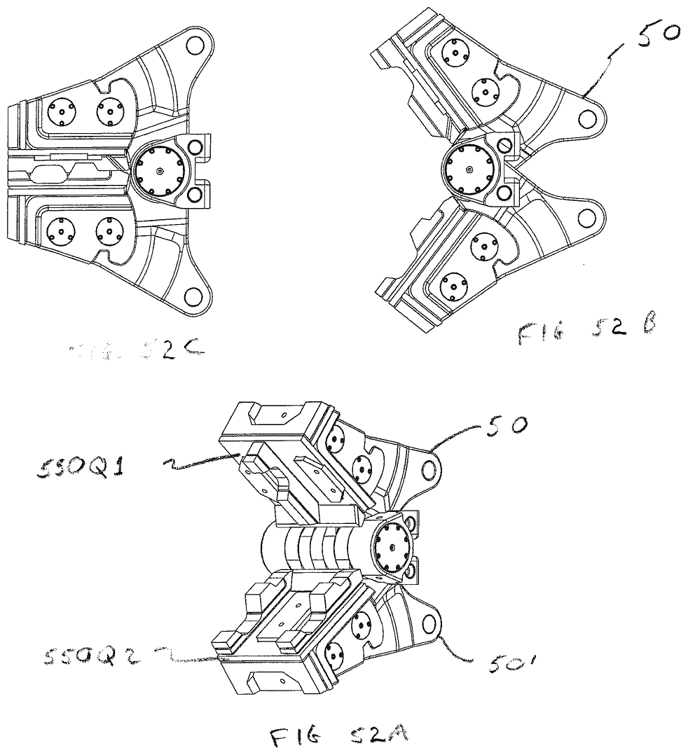

FIGS. 52A-52C illustrate a rail breaker with platforms 50, 50′ and segment shields 550Q1, 550Q2;

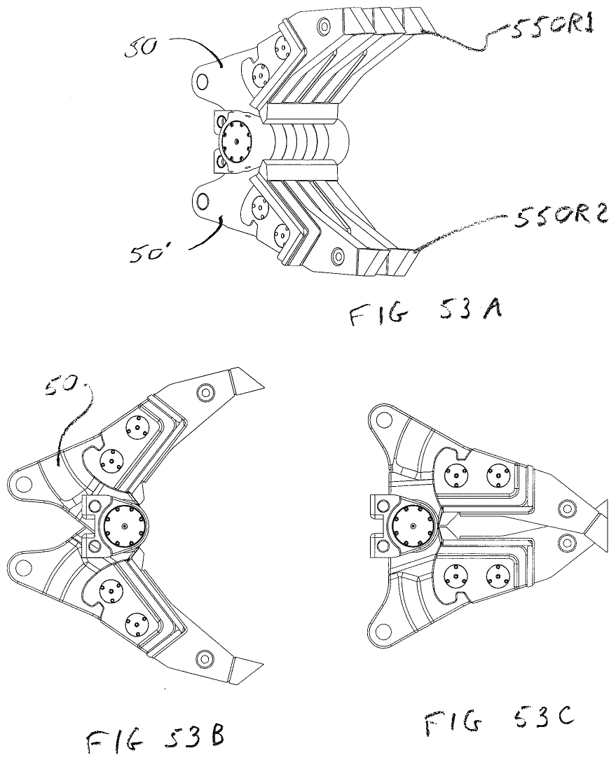

FIGS. 53A-53C illustrate a grapple with platforms 50, 50′ and segment shields 550R1, 550R2;

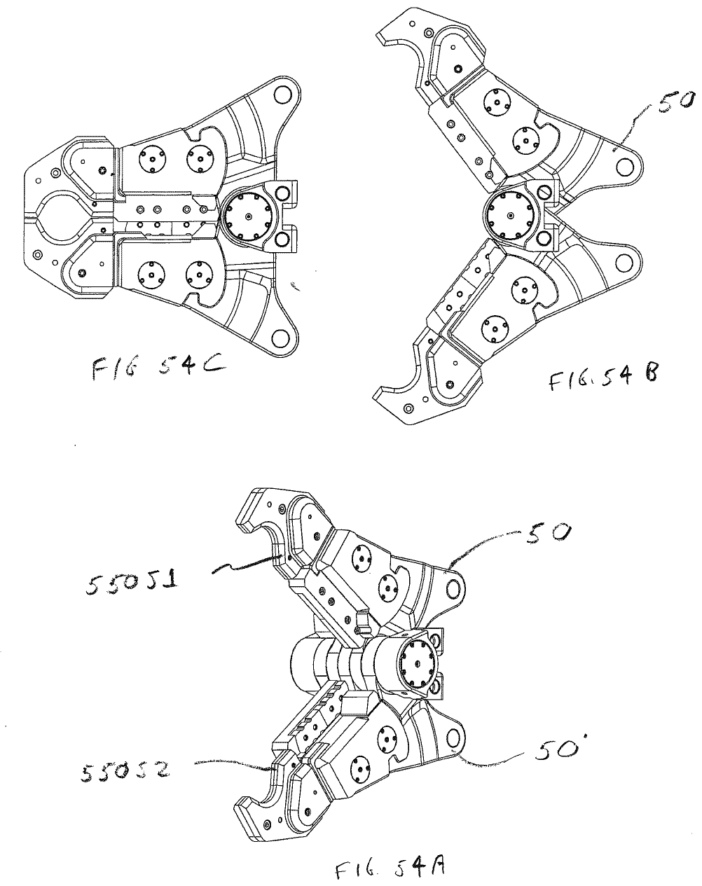

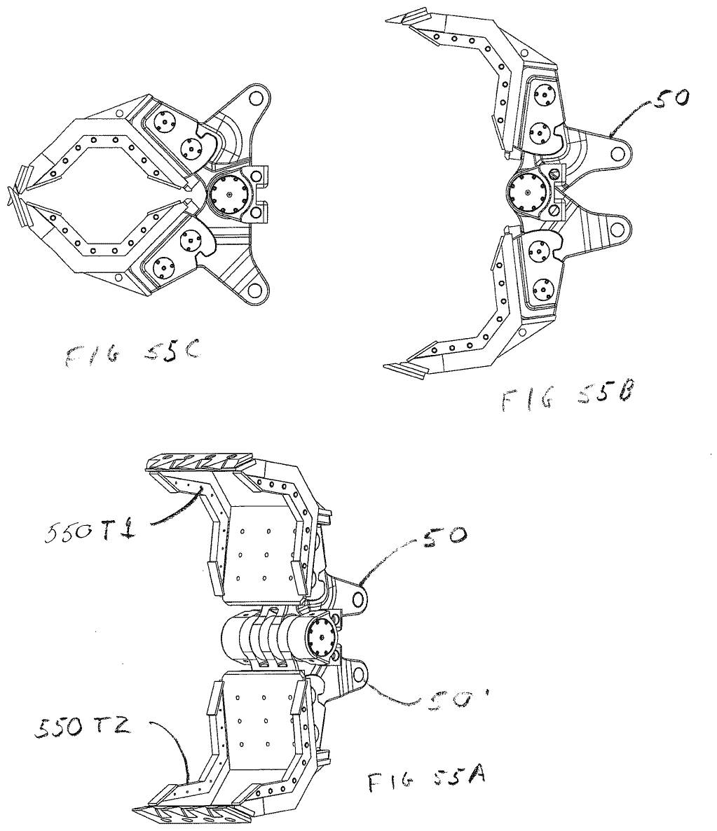

FIGS. 54A-54C illustrate a combi with platforms 50, 50′ and segment shields 550S1, 550S2;

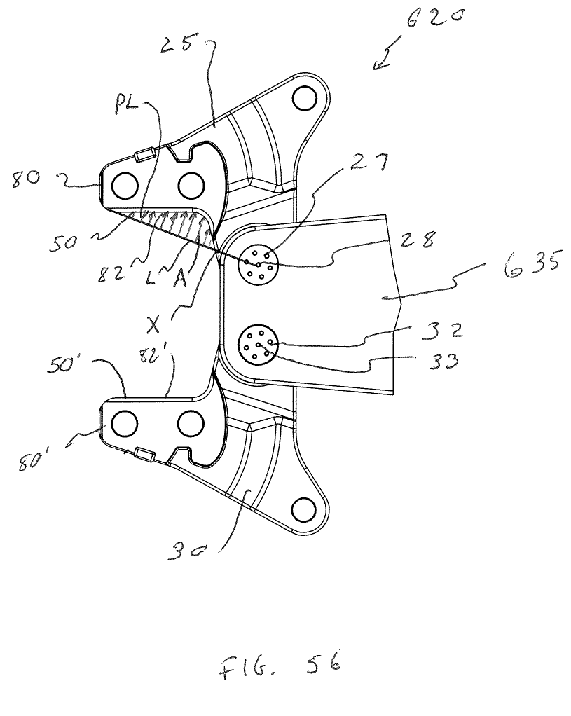

FIGS. 55A-55C illustrate a bucket grab i with platforms 50, 50′ and segment shields 550T1, 550T2; and

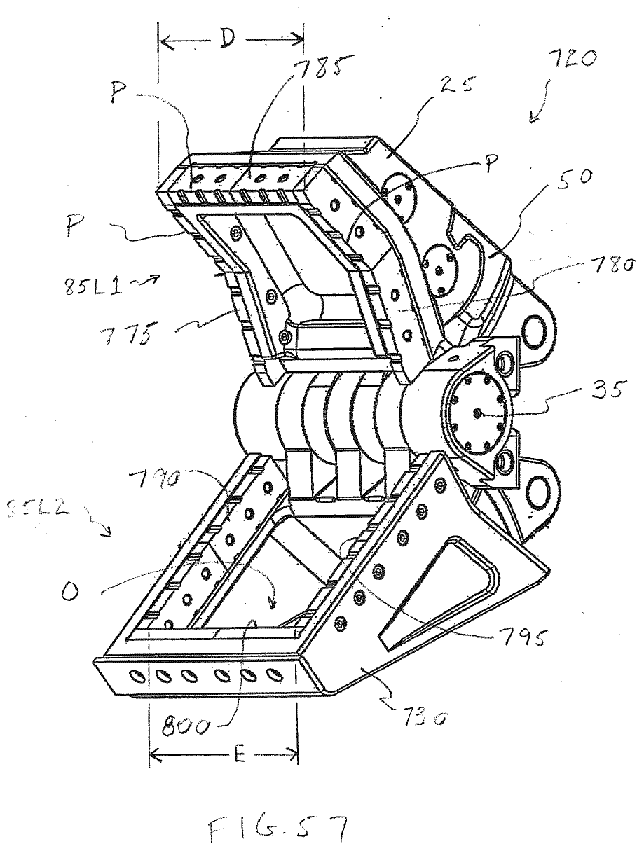

FIG. 56 illustrates a jaw set 620 whereby each jaw is mounted to a separate pivot pin.

So far discussed is a working shield 550 mounted upon the platform 50 of a first jaw 25 or a second jaw 30 wherein the first jaw 25 and the second jaw 30 are mounted about a common pivot pin. Directing attention to FIG. 56, it is possible for a jaw set 620 to be made up of the first jaw 25 having a pivot pin 27 about a first axis 28 and a second jaw 30 having a pivot pin 32 about a second axis 33, whereby the first pivot pin 27 and the second pivot pin 32 are spaced apart from one another. It should be noted that the first jaw 25 and the second jaw 30 are similar to those already discussed but are mounted about a receiver 635 that allows them to be space apart.

The arrangement in FIG. 56 shows the first jaw 25 and the second jaw 30 mounted within the jaw set 620 with the jaws 25, 30 in the closed position.

Discussed herein will be the first jaw 25. However, it should be understood that the same discussion applies to the second jaw 30. For similar elements, the second jaw 30 will use the same reference numerals but for the second jaw 30 those reference numerals will include a “′” such as, for example, platforms 50, 50′.

Although the pivot pin 27 of the first jaw 25 and the pivot pin 32 of the second jaw 30 are spaced apart from one another, the details of each jaw 25, 30 are similar to those previously discussed with one exception. The platform length PL will be defined by a line L extending from the front end of the platform 50 to the axis of the pivot pin for each jaw, rather than the throat 570 of each jaw. However, the platform length PL will only be measured to the point where the line intersects with the inner surface of the jaw.

In particular, directing attention to first jaw 25 in FIG. 56, a platform 50 extends along an inner surface 82 from the front end 80 of the jaw 25 toward the pivot pin axis 28.

In order to determine the coverage provided to the platform 50 by the working shield 550, a platform length PL is defined by a perpendicular projection from a line L extending from the front end 80 of the platform 50 to the axis 28 of the first pivot pin 27. The platform length PL is measured to the point X. The point X is where the line L intersects with the inner surface 82 of the jaw 25. As illustrated in FIG. 56 the arrows A projected from the line L intersect with the jaw 25. In this manner the coverage of the platform 50 provided by the working shield 550 may be measured.

The same configurations as those illustrated and discussed with respect to FIGS. 38-40 also apply to the arrangement shown in FIG. 56. In one embodiment, the working shield 550 extends along at least 50% of the line L to illustrate coverage of the platform 50. In another embodiment, the working shield 550 extends along at least 70% of the line L to illustrate coverage of the platform 50. In yet another embodiment, the working shield 550 extends along at least 90% of the line L to illustrate coverage of the platform 50.

What has so far been discussed is an arrangement in which both jaws have a working shield made up of a removeable segment or a removable base and segment shell. FIG. 57 shows a jaw set with only one jaw 25 using a removable segment 85L1. The other jaw 30 is dedicated to a particular purpose 85L2 and does not have such a removeable segment.

FIG. 57 illustrates a jaw set 720 for demolition, recycling, or material processing equipment, wherein the jaw set 720 has a first jaw 25 and a second jaw 730. The first jaw 25 is secured to the second jaw 730 with a pivot pin 35 to allow relative rotation between the first jaw 25 and the second jaw 730. The first jaw 25 has a front end 80 (FIG. 41) and an inner surface 82 (FIG. 41). The first jaw 25 has a platform 50 (FIG. 41) extending along the inner surface 82 from the front end 80 of the first jaw 25 jaw toward the pivot pin 35. The first jaw 25 also has a working shield 85L1 secured to the jaw 25. The working shield 85L1 has working surfaces for engaging a workpiece. The working shield 85L1 has a cavity 95 (FIG. 4) with a shape complimentary to the platform 50. The working shield 85L1 covers portions of the platform 50 that experience compressive forces when the jaws 25, 730 are moved against a workpiece from an open position to a closed position.

The second jaw 730 has a dedicated configuration with a working surface opposing the working shield 85L1 of the first jaw 25. The working surface of the dedicated configuration engages with the first jaw 25 for operation on a workpiece. The dedicated configuration of the second jaw 730 is an integral part of the second jaw 730.

In one embodiment, the first jaw 25 is comprised of a plurality of shear blades defining a perimeter P. The working shield 85L1 of the first jaw 25 has at least one first jaw left inner blade 775 and at least one first jaw right inner blade 780 secured to the jaw, each perpendicular to the pivot pin 35, parallel to one another, and extending in a direction from the pivot pin 35 toward an outer edge of the jaw 25 furthest from the pivot pin 35. The outer surfaces of the at least one first jaw left inner blade 775 and the at least one first jaw right inner blade 780 are separated by a distance D.

The first jaw 25 also has at least one first jaw outer blade 780 secured to the jaw 25, parallel to the pivot pin 35, and proximate to the first jaw outer edge between the at least one first jaw left inner blade 775 and the at least one first jaw right inner blade 780.

The second jaw 730 has at least one second jaw left inner blade 790 and at least one second jaw right inner blade 795 secured to the second jaw 730, each perpendicular to the pivot pin, parallel to one another, extending in a direction from the pivot pin 35 toward an outer edge of the second jaw 730. The second jaw inner surfaces of the at least one second jaw left inner blade 790 and the second jaw right inner blade 795 are separated by a distance E. Distance D is up to 95% of distance E, but less than distance E, such that when the jaws 25, 730 are being closed, the at least one first jaw inner blades 775, 780 of the first jaw 25 are encompassed by the at least one second jaw inner blades 790, 795 of the second jaw 730 to provide lateral stability to the first jaw 25 as it operates upon a workpiece.

Such stability is enhanced because the first jaw inner blades 775, 780 first engage the second jaw inner blades 790, 795 at a point closest to the pivot. Essentially, the first jaw 30 engages the second jaw 730 at the beginning of the compression process to provide lateral support at the beginning of a cut. Also, by using a shear having such shaped jaws, the size and shape of the severed workpiece may be predetermined and, depending on the dimensions of the shear, may be customized for a particular customer or downstream processing technique. This is significantly different from conventional shears in which the jaws first engage one another at the outer tip of the jaws and the workpiece is deformed to a greater degree.

The second jaw 730 also has at least one second jaw outer blade 800 secured to the second jaw 790, parallel to the pivot pin 35 and proximate to the second jaw outer edge furthest from the pivot pin 35 between the at least one second jaw left inner blade 790 and the second jaw right inner blade 795.

Additionally, as seen in FIG. 57, the at least one second jaw inner blades 790, 795 and the at least one second jaw outer blade 800 outline an opening O extending through the second jaw 790 which allows a workpiece, once severed, to fall through the opening O without incurring deformation beyond that caused by the shearing action of the jaws 25, 790.

In such a fashion, the shear may be used on, for example, a flat plate and upon shearing a segment of the flat plate, generally in the shape of the opening O, the severed portion of the flat plate may remain essentially flat and passes through the opening. This greatly enhances the ability to collect and store the removed plate segments. While a flat plate was used as an example, other workpieces may also be acted upon. Not only does the design of the shear limit deformation of the workpiece, but it also allows a workpiece to be cut to specific dimensions as may be requested by a customer for further processing. For another example, a cluster of wire may be sheared into a shape resembling the opening O.

As illustrated in certain of FIGS. 50-56, the working shield 550 on each jaw may be dedicated to a particular demolition, recycling, or material processing operation and is comprised of a dedicated tool part from the group comprised of a concrete crusher, a concrete cracker, a cast breaker, a rail breaker, sorting tines, grapple tines, a bucket fabrication, a bucket grab, a tree shear, a slab processor, a heavy melt segment shear, and a heavy melt shear.

On the other hand, as illustrated in other of these figures, the working shield 550 on each jaw may be comprised of any number of working surfaces, while the working shield 550 has the same cavity for mating with the platform 50, wherein each different working surfaces is configured for a different demolition, recycling, or material processing operation

There are multiple advantages provided by the design discussed herein. In the past, there were at least three different protocols when the specific working task of a machine was to change. It was possible to install a dedicated stand-alone tool onto a machine for each particular working task. However, this first required removing the currently mounted tool from the machine before the desired tool could be installed. Removal required not only dismounting the current tool from the boom, but also detaching the linkages and hydraulic hoses of the current tool from the boom. Thereafter, this entire process was repeated in reverse to install the desired tool. This required significant time and resources. Furthermore, this required the user to own/rent multiple dedicated tools which required the capacity to transport these tools.

Another protocol for accommodating different working tasks required of a machine would involve replacing removable dedicated jaws sets. While this was to some extent a more effective manner of addressing the challenge of multiple functions, it required multiple duty specific jaw sets to be used which may be expensive.

Yet another protocol involved utilizing a single jaw set but providing customized inserts or blades on the jaws of the jaw set to accommodate different working tasks. This provided a compromise solution because while a single jaw set may be optimized for a particular working task, when blades or inserts were added to the jaws of the jaw set for other working tasks, the end result was no longer an optimized tool.

Overall, modifying machines or tools to accommodate different working tasks is an expensive, laborious, and time-consuming process. By using the segments as described herein, a jaw set can be retained and only the segments attached to the jaws would have to be changed. This results in a more economical and less laborious tool swap that does not hinder optimized tool performance.

Furthermore, with prior designs, the jaw set, including the body of the jaw, would be exposed to the workpiece and, as a result, experience premature wear. Replacement or refurbishment of a jaw or the jaw set is very expensive and time consuming. By using the segments and platforms as described herein, essentially only the segments are exposed to the workpiece. Therefore, most of the time, only the segments would have to be repaired or replaced. As described herein, replacement of the segments is straight forward and may be performed in the field with much greater efficiency than that required to replace an entire jaw set.

Furthermore still, the cost of the segments is significantly less than the cost of a jaw or a jaw set so the cost to use the tool over time is greatly reduced.

As a result, the ability to modify a machine to perform any number of different working tasks is made much easier, is significantly less expensive, takes less time, and may be performed in the field in a relatively straight forward manner, when compared to replacing or servicing a dedicated tool or an entire jaw set.

The present embodiments are merely intended to be illustrative of the present invention and not restrictive thereof. It would be apparent to those of ordinary skill in the art that various modifications may be made to the present invention without departing from the spirit and scope thereof.

The invention claimed is:

1. A jaw set for demolition, recycling, or material processing equipment, wherein the jaw set has a first jaw and a second jaw, wherein the first jaw is secured to the second jaw with a pivot pin about a pivot group and adapted to allow relative rotation between the first jaw and the second jaw, wherein each jaw has a front end and an inner surface, wherein with each jaw in a closed position, a throat is defined by the overlapping portion of the inner surface of the two jaws at a point closest to the pivot group, wherein each jaw comprises:
a) a platform extending along the inner surface from the front end of the jaw to the throat; and the platform with the jaws in the closed position has a platform length defined by a perpendicular projection from a line extending from the front end of the platform to the throat; and
b) a working shield secured to the jaw, wherein the working shield has working surfaces for engaging a workpiece and wherein the working shield has a cavity with a shape complimentary to the platform, wherein the working shield covers portions of the platform that experience compressive forces when the jaws are moved against a workpiece from an open position to a closed position.

2. The jaw set according to claim 1, wherein the working shield extends along at least 50% of the platform length.

3. The jaw set according to claim 1, wherein the working shield extends along at least 70% of the platform length.

4. The jaw set according to claim 1, wherein the working shield extends along at least 90% of the platform length.

5. The jaw set according to claim 1, wherein the working shield is comprised only of a segment with a working surface that engages a workpiece.

6. The jaw set according to claim 1, wherein the working shield is comprised of a segment shell and a base, with the base secured to the platform and the segment shell secured to the base.

7. The jaw set according to claim 6, wherein the segment shell only provides the working surface and completely covers the base.

8. The jaw set according to claim 7, wherein the base covers at least 90% of the inner surface of the platform.

9. The jaw set according to claim 7, wherein the segment shell extends beyond the base in the direction toward the throat such that the segment shell contributes to protecting the platform.

10. The jaw set according to claim 6, wherein the segment shell and base together provide the working shield, the segment shell extends along a portion of the platform and the base extends over an adjacent portion of the platform in the direction of the throat.

11. The jaw set according to claim 1, wherein
a) the jaw of each platform has a bore to accept the pivot pin extending therethrough about a rotational axis, wherein the platform extends away from the rotational axis to define a first side, a second side opposite to the first side, a first flank and a second flank opposite to the first flank, wherein the first side and second side are between the first flank and second flank, and a front end defined by the intersection of the ends of the sides and flanks furthest from the rotational axis; and
b) a working shield secured to the platform, wherein the working shield has working surfaces for engaging a workpiece and wherein the working shield has a cavity with a shape complimentary to the platform which receives the first flank, the second flank, and the first side of the platform, such that at those locations the platform is shielded from direct engagement with the workpiece.

12. The jaw set of claim 11, wherein the cavity of the working shield further includes a shape complimentary to the front end of the platform such that the front end of the platform is also shielded from direct engagement with the workpiece.

13. The jaw set according to claim 1, wherein the working shield protrudes beyond the front end of the platform.

14. The jaw set according to claim 1, wherein each platform has a platform first bore and the working shield has a working shield first bore, wherein with the platform and working shield mated, the platform first bore is co-axial with the working shield first bore to accept a first locking pin.

15. The jaw set according to claim 14, wherein the working shield pivots about the first locking pin to engage with the platform.

16. The jaw set according to claim 14, wherein the working shield has a hook portion and the platform has a complimentary hook portion, which are engaged with one another when the working shield pivots to engage with the platform.

17. The jaw set according to claim 1, wherein the cavity of the working shield has a first wall and an opposing second wall, and also has a front wall and an inner wall therebetween, connecting the first wall to the second wall.

18. The jaw set according to claim 1, wherein a fit between the pivot pin and the bore of the first jaw is a slip fit.

19. The jaw set according to claim 1, wherein the first wall and the second wall of the working shield have opposing recesses and an alignment bar is secured to the platform, wherein the alignment bar engages the opposing recesses to limit motion between the platform and the working shield.

20. The jaw set according to claim 19, wherein the tolerances for the engagement of the alignment bar between the platform and the working shield are less than those between the platform and working shield such that the alignment bar provides tighter tolerances to secure and align the working shield relative to the platform.

21. The jaw set according to claim 19, wherein the alignment bar retains the working shield to the platform when the first and second locking pins are removed.

22. The jaw set according to claim 1, wherein the working shield on each jaw is dedicated to a particular demolition, recycling, or material processing operation and is comprised of a dedicated tool part from the group comprised of a concrete crusher, a concrete cracker, a cast breaker, a rail breaker, sorting tines, grapple tines, a bucket fabrication, a bucket grab, a tree shear, a slab processor, a heavy melt segment shear, and a heavy melt shear.

23. The jaw set according to claim 1, wherein the working shield on each jaw may be comprised of any number of working surfaces, while the working shield has the same cavity for mating with the platform, wherein each different working surfaces is configured for a different demolition, recycling, or material processing operation.

24. A jaw set for demolition, recycling, or material processing equipment, wherein the jaw set has a first jaw secured with a first pivot pin with an axis therethrough and a second jaw secured with a second pivot pin with an axis therethrough spaced apart from the first pivot pin, wherein each jaw has a front end and an inner surface, wherein with each jaw in a closed position, each jaw comprises:
a) a platform extending along the inner surface from the front end of the jaw toward the pivot pin; and the platform with the jaws in the closed position has a platform length defined by a perpendicular projection from a line extending from the front end of the platform toward the axis of pivot pin to the inner surface of the jaw; and
b) a working shield secured to the jaw, wherein the working shield has working surfaces for engaging a workpiece and wherein the working shield has a cavity with a shape complimentary to the platform, wherein the working shield covers portions of the platform that experience compressive forces when the jaws are moved against a workpiece from an open position to a closed position.

25. The jaw set according to claim 24, wherein the working shield extends along at least 50% of the platform length.

26. The jaw set according to claim 24, wherein the working shield extends along at least 70% of the platform length.

27. The jaw set according to claim 24, wherein the working shield extends along at least 90% of the platform length.

28. The jaw set according to claim 24, wherein the working shield is comprised only of a segment with a working surface that engages a workpiece.

29. The jaw set according to claim 24, wherein the working shield is comprised of a segment shell and a base, with the base secured to the platform and the segment shell secured to the base.

30. The jaw set according to claim 29, wherein the segment shell only provides the working surface and completely covers the base.

31. The jaw set according to claim 29, wherein the base covers at least 90% of the inner surface of the platform.

32. The jaw set according to claim 29, wherein the segment shell extends beyond the base in the direction toward the throat such that the segment shell contributes to protecting the platform.

33. A jaw set for demolition, recycling, or material processing equipment, wherein the jaw set has a first jaw and a second jaw, wherein the first jaw is secured with a pivot pin to allow relative rotation between the first jaw and the second jaw, wherein the first jaw has a front end and an inner surface, wherein the jaw set comprises:
a) the first jaw having:
1. a platform extending along the inner surface of the first jaw from the front end of the jaw toward the pivot pin; and
2. a working shield secured to the jaw, wherein the working shield has working surfaces for engaging a workpiece and wherein the working shield has a cavity with a shape complimentary to the platform, wherein the working shield covers portions of the platform that experience compressive forces when the jaws are moved against a workpiece from an open position to a closed position; and
b) the second jaw having a dedicated configuration with a working surface opposing the working shield of the first jaw, wherein the working surface of the dedicated configuration engages with the first jaw for operation on a workpiece, and wherein the dedicated configuration of the second jaw is an integral part of the second jaw.

34. The jaw set according to claim 33, wherein:
a) the first jaw is comprised of a plurality of shear blades defining a perimeter wherein the working shield of the first jaw is comprised of:
1. at least one first jaw left inner blade and at least one first jaw right inner blade secured to the jaw, each perpendicular to the pivot pin, parallel to one another, extending in a direction from the pivot pin toward an outer edge of the jaw, wherein outer surfaces of the at least one first jaw left inner blade and the at least one first jaw right inner blade are separated by a distance D, and
2. at least one first jaw outer blade secured to the jaw and parallel to the pivot pin and proximate to the first jaw outer edge furthest from the pivot pin between the at least one first jaw left inner blade and the at least one first jaw right inner blade; and
b) the second jaw comprised of:
1. at least one second jaw left inner blade and at least one second jaw right inner blade secured to the second jaw, each perpendicular to the pivot pin, parallel to one another, extending in a direction from the pivot pin toward an outer edge of the second jaw furthest from the pivot pin, wherein second jaw inner surfaces of the at least one second jaw left inner blade and the at least one second jaw right inner blade are separated by a distance E, wherein distance D is up to 95% of E but less than E, such that when the jaws are being closed, the at least one first jaw inner blades of the first jaw are encompassed by the at least one second jaw inner blades of the second jaw to provide lateral stability to the first jaw; and
2. at least one second jaw outer blade secured to the second jaw and parallel to the pivot pin and proximate to the second jaw outer edge furthest from the pivot pin between the second jaw left inner blade and the second jaw right inner blade.

35. The jaw set according to claim 34, wherein the at least one second jaw inner blades and the at least one second jaw outer blade outline an opening extending through the second jaw which allows a workpiece, once severed, to fall through the opening without incurring deformation beyond that caused by the shearing action of the jaws.
